(19) United States
(12) Patent Application Publication
(10) Pub. No.: US 2009/0004452 A1
(43) Pub. Date: Jan. 1, 2009

(54) TRANSFER PAD

(76) Inventor: KENNETH ASSINK, Holland, MI (US)

Correspondence Address: ILLINOIS TOOL WORKS INC., 3600 WEST LAKE AVENUE, PATENT DEPARTMENT, GLENVIEW, IL, 60025, US

(21) Appl. No.: 12/208,614

(22) Filed: Sep. 11, 2008

Related U.S. Application Data
(63) Continuation-in-part of application No. 11/503,789, filed on Aug. 14, 2006.
(60) Provisional application No. 60/716,399, filed on Sep. 13, 2005.

(51) Int. Cl. B32B 33/00

(52) U.S. Cl. 428/220; 428/98

(57) ABSTRACT

A pad is described comprising a padding layer and at least one sheet layer adjacent to the padding layer. The sheet layer is formed from a web of very fine fibers. The padding layer provides support for the patient. The sheet layer comprises a fabric material that is comfortable for the patient to use. The padding layer and the one or more sheet layer(s) exhibit a particular combination of properties such as high strength and high fluid absorption and retention properties. The pad provides a means for either adjusting a patient within a bed or for transferring a patient from one bed to another bed or medical table. The pad may also be used as part of a stretcher or separately as a bedroll. The pad may optionally contain gripping components and drapes.

### CROSS REFERENCES TO RELATED APPLICATIONS

This application is a continuation-in-part (CIP) application of U.S. Ser. No. 11/503,789 filed Aug. 14, 20061, which claims priority from U.S. provisional application Ser. No. 60/716,399 filed Sep. 13, 2005, which is herein incorporated by reference.

### BACKGROUND OF THE INVENTION

For a variety of reasons and situations, patients in a hospital or medical environment frequently need to be moved. A patient may need to be moved to reposition the patient within their bed, transfer the patient from one bed to another bed or medical table, or to change the patient's bedding. However, several problems may be encountered in the movement of a patient. Physically lifting the patient may require several medical staff members to lift the patient to ensure that the patient's limbs and/or extremities are not loose and subject to jostling or random motions that may cause discomfort. Even if several people assist in the lifting of the patient, the patient may be subjected to subtle movements in direction if the people moving the patient do not act in concert with one another. Problems are also encountered when it is necessary to either adjust the patient's position in the bed or transfer them to another bed. The patient is potentially subjected to numerous movements, each with the potential for increasing the discomfort of the patient, or as may be the case with elderly patients, inflicting additional harm. Although various techniques and devices are available for moving a patient, a need exists for an improved device and/or strategy.

Military personnel may use a stretcher that includes one or more flexible fabrics or material layers which may be drawn between two rigid poles to transport a soldier from the field to receive medical aid. Such flexible materials should be strong enough to bear the weight of a soldier who may be placed thereon. The stretcher should also be tear-resistant and waterproof in order to prolong its operational life. However, current fabrics or materials used in military stretchers often fail when subjected to loads of about 200 pounds, particularly if the fabric degrades or ages. In addition, stretchers using rigid poles are cumbersome to store and require large amounts of space. Thus, there is a need for an improved stretcher or layered material assembly that can support relatively high loadings and which is exceptionally durable, and particularly one that does not require rigid poles.

Patients or individuals laying on a transfer pad or stretcher may as a result of injury, unconsciousness, or other reason, release bodily fluids onto the transfer pad or stretcher. Examples of such fluids include, but are not limited to blood and urine. In the event of such occurrence, it is undesirable to allow the fluids to flow or drip onto the underlying surface or to regions external to the pad or stretcher. Instead, it would be desirable to retain those fluids in the transfer pad or stretcher for subsequent collecting or discarding.

Soldiers, as well as recreational outdoor enthusiasts, frequently carry bedrolls with them that provide a light, portable, comfortable place for them to sleep and protect them from varying ground conditions. Since such bedrolls are typically carried by the individual, it is important that the bedroll be lightweight and foldable to a compact state. Currently available bedrolls, although satisfactory in many regards, could be further improved.

Accordingly, it would be desirable to provide a device or system that provides for an effective means of moving a patient that minimizes the discomfort encountered by the patient in any such move and aids personnel in moving the patient.

It would also be desirable to provide a stretcher-like device or layered material assembly which exhibits a high load-bearing capacity. It would further be desirable to provide such a device that did not require rigid poles, yet which could be used to carry patients or relatively heavy loads without ripping, tearing, or otherwise rupturing. Moreover, it would be particularly beneficial if such device was durable and exhibited resistance to abrasive wear and environmental factors.

In addition, it would be desirable to provide a transfer pad or stretcher-like device that retained and collected fluids such as body fluids, rather than letting those fluids be transferred to other surfaces and into the environment.

It would also be desirable to provide an improved lightweight, portable, comfortable device or system that may be used as a bedroll.

### SUMMARY OF THE INVENTION

The present invention achieves all of the noted objectives. In one aspect, the present invention provides a multilayer flexible thin pad comprising at least one breathable sheet layer. The thin pad further comprises a padding layer comprising polyester fibers. The at least one sheet layer and the padding layer are adhesively bonded to one another by use of a hot melt polyester based adhesive layer disposed between the at least one sheet layer and the padding layer. The pad exhibits a relatively high surface area to thickness ratio of from about 800:1 to about 50,000:1. Despite its high surface area to thickness ratio, the pad exhibits a unique combination of strength and liquid retention properties. Generally, the pad can support loads of 400 pounds without ripping, tearing or otherwise rupturing. And, the pad can absorb and retain 1 ounce of liquid for every 40 square inches of pad surface area.

In another aspect, the present invention provides a flexible thin pad comprising at least one sheet layer, the sheet layer being breathable and the sheet layer comprising a blend of polyethylene fibers and polyester fibers. The thin pad also comprises a padding layer comprising polyester fibers. The at least one sheet layer and the padding layer are adhesively bonded to one another by use of a hot melt polyester based adhesive layer disposed between the at least one sheet layer and the padding layer. The pad exhibits a surface area to thickness ratio of from about 800:1 to about 50,000:1. The pad can support loads of 400 pounds without ripping, tearing or otherwise rupturing. The pad can absorb and retain 1 ounce of liquid for every 40 square inches of pad surface area. The pad exhibits a width to length ratio of about 23% to about 40%.

In yet another aspect, the present invention provides a flexible thin pad comprising at least one sheet layer, the sheet layer being breathable and the sheet layer comprising a blend of cellulose fibers and polyester fibers. The thin pad also comprises a padding layer comprising polyester fibers. The at least one sheet layer and the padding layer are adhesively bonded to one another by use of a hot melt polyester based adhesive layer disposed between the at least one sheet layer and the padding layer. The pad exhibits a surface area to thickness ratio of from about 800:1 to about 50,000:1. The pad can support loads of 400 pounds without ripping, tearing or otherwise rupturing. The pad can absorb and retain 1 ounce of liquid for every 40 square inches of pad surface area. The pad exhibits a width to length ratio of from about 46% to about 79%.

### BRIEF DESCRIPTION OF THE DRAWINGS

The following detailed description may be more readily understood when read in reference to the accompanying drawings:

FIG. 1a is a perspective view of a first embodiment of a bed pad according to the present invention.

FIG. 1b is a side view of the bed pad in FIG. 1a.

FIG. 2 is a side view of a second embodiment of a bed pad according to the present invention.

FIG. 3 is a perspective view of a third embodiment of a bed pad according to the present invention.

FIG. 4a is a perspective view of a fourth embodiment of a bed pad according to the present invention.

FIG. 4b is a perspective view of a fifth embodiment of a bed pad according to the present invention.

FIG. 5 is a perspective view of a sixth embodiment of a bed pad according to the present invention.

FIG. 6 is a perspective view of a seventh embodiment of a bed pad according to the present invention.

FIG. 7 is a perspective view of an eighth embodiment of a bed pad with drapes according to the present invention.

FIG. 8 is a perspective view of a ninth embodiment of a bed pad according to the present invention.

FIG. 9a is a top planar view of a bed pad with hinge providing tabs according to the present invention.

FIG. 9b is a top planar view of another bed pad with tabs according to the present invention.

FIG. 10 is a perspective view of two bed pads which have been attached to each other using tabs provided on each bed pad.

FIG. 11 is a perspective view of another bed pad embodiment having openings and drapes.

FIG. 12 is a top planar view of another bed pad embodiment having openings and tabs.

FIG. 13 is a perspective view of another embodiment of a bed pad according to the present invention.

FIG. 14 is a detailed view of a corner region of the pad depicted in FIG. 13.

FIG. 15 is an exploded schematic view illustrating the assembly or construction of the pad depicted in FIG. 13.

FIG. 16 illustrates the pad of FIG. 13 in a folded and compact state.

FIG. 17 is a perspective view of yet another embodiment of a bed pad according to the present invention.

FIG. 18 is a detailed view of a corner region of the pad depicted in FIG. 17.

FIG. 19 is an exploded schematic view illustrating the assembly or construction of the pad depicted in FIG. 17.

### DETAILED DESCRIPTION OF THE PREFERRED EMBODIMENTS

The pads of the present invention can be utilized and embodied in a wide array of different forms. For example, the pads can be in the form of bed pads and thus find application in hospitals, clinics, and other medical settings. The pads can be in the form of transfer pads or stretchers which may also find wide applications in the medical field and in military applications. Furthermore, the pads can be in the form of bedrolls or ground liners such as when laying upon the ground. Specifically, a pad is provided that comprises at least two layers and is capable of being used as an aid for the easy adjustment of patients within a bed and/or the easy transfer of a patient from one bed to another bed or medical table. The pad can also be used by itself as a stretcher or as the flexible material between the two poles in a conventional stretcher or, carried separately, as a bedroll. The present invention pad can serve multiple applications, and so is generally referred to herein as a “pad”, “transfer pad”, “bed pad”, “bed roll” or the like. A bed pad according to the present invention comprises a padding layer and at least one sheet layer adjacent to the padding layer. Preferably, these layers exhibit particular properties as described herein and are adhesively bonded together. The padding layer is comprised of a pad or mat and provides support for the bed pad of the invention. The sheet layer is a layer adjacent to the padding layer, and provides the surface upon which the patient lies. Other layers may be included depending upon the end use application.

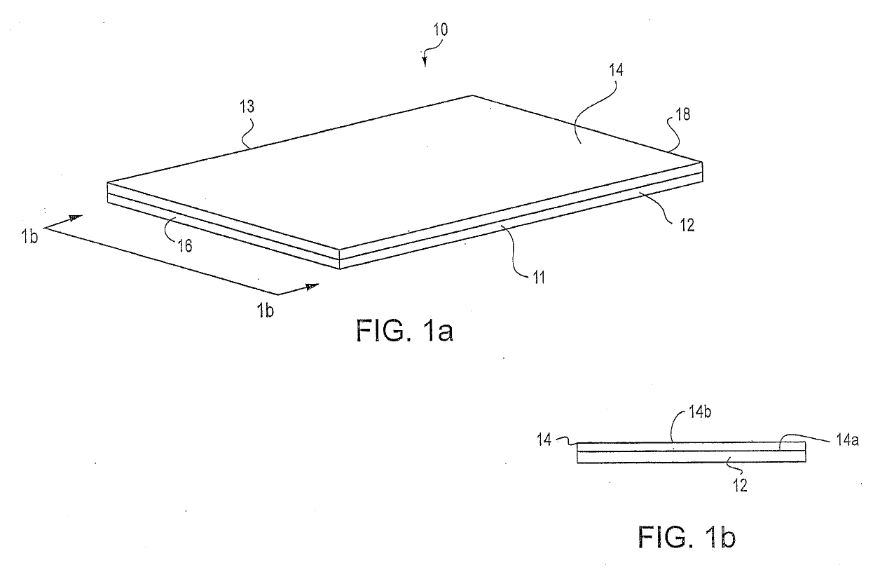

In a first configuration, such as the embodiment shown in FIG. 1a and 1b, a bed pad 10 according to the invention is a two-layer or laminate construction comprising a padding layer 12 and a sheet layer 14 adjacent to the padding layer. The sheet layer comprises two surfaces or faces, one surface 14a which is in contact with a surface of the padding layer, and an exposed surface 14b. The exposed surface provides the outer surface of the bed pad and is generally the surface upon which the person lies. Alternatively, in this configuration, a person could be placed on the exposed surface of the padding layer, i.e., the surface which is not in direct contact with a surface of the sheet layer. However, due to the materials from which the respective layers are made (discussed further herein), the person usually lies or is placed upon the sheet layer. The bed pad has two sides, 11 and 13, which are preferably straight and extend parallel to each other along the length of the bed pad. The bed pad 10 also has two ends, 16 and 18, which extend along the width of the bed pad. While the two ends are depicted here as straight and parallel to each other, they may have independently different lengths and shapes. For example, the ends may be in the form of a curve such as a half-circle. In one variant embodiment, the bed pad might have the shape of a rectangle with two half-circles at each end.

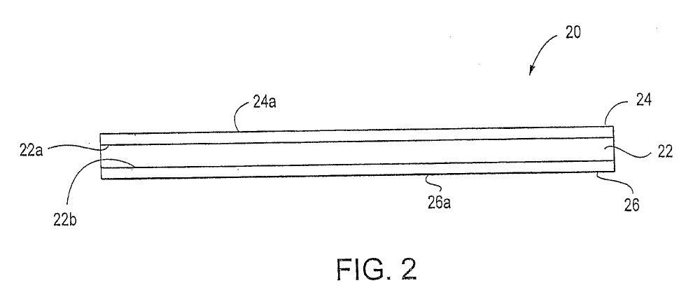

FIG. 2 depicts a second embodiment of a bed pad according to the present invention. The bed pad 20 is a three-layer laminate or sandwich construction comprising a padding layer 22 having a first surface 22a and a second surface 22b, a first sheet layer 24 adjacent to one of the surfaces of the padding layer, and a second sheet layer 26 adjacent to the other surface of the padding layer. The two sheet layers provide a bed pad having two exposed sheet surfaces, e.g. 24a and 26a, upon which the person may lie. In the bed pad depicted in FIG. 2, the sheet layers have the same dimensions as the padding layer and thus the periphery or sides of the padding layers are exposed. Optionally, the sheet layers may have dimensions such that a portion of the ends and sides of the sheet layers extend beyond the ends and sides of the padding layer. The excess portions of the sheet layers may then be attached to one another, thereby fully enclosing the padding layer. The side of the bed pad contacting the bed, which may be the padding layer in the two-layer construction of FIG. 1 or one of the sheet layers in the three-layer construction of FIG. 2, may have a low coefficient of friction to facilitate easy sliding of the bed pad.

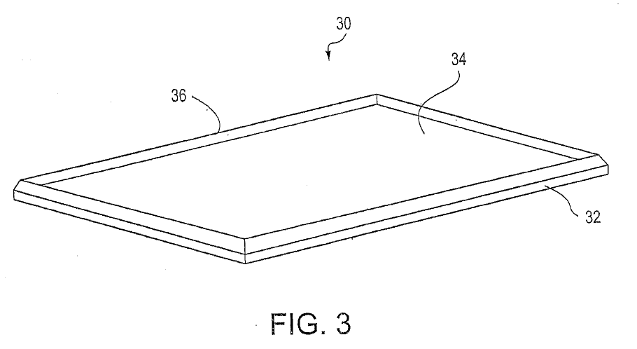

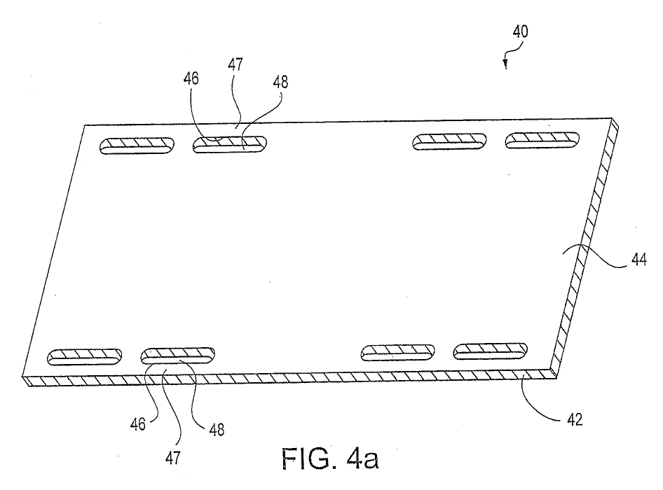

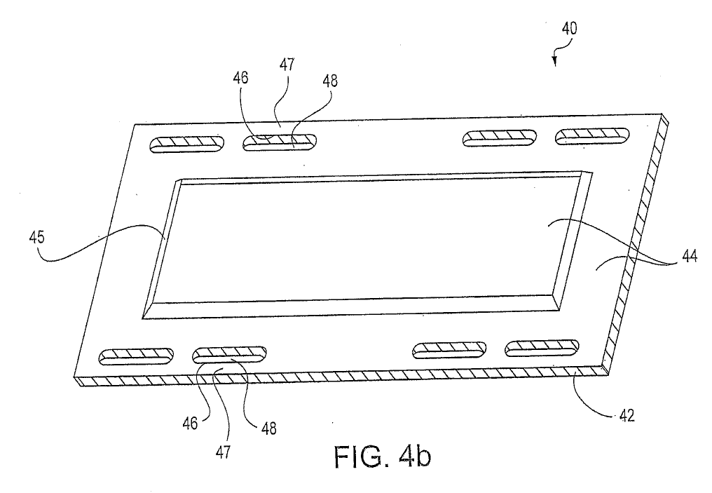

Additionally, a bed pad may utilize a border extending from the top surface of the bed pad, i.e., extending from the exposed surface of the sheet layer. The embodiments depicted in FIGS. 3 and 4b include such a border. In FIG. 3, the bed pad 30 comprises a padding layer 32 and a sheet layer 34 adjacent thereto (similar to the bed pad depicted in FIGS. 1a and 1b). The bed pad 30 further comprises a border 36 adjacent to the top surface of the top layer and extending around the periphery of the sheet layer. FIG. 4b depicts another embodiment that includes a border. In FIG. 4b, the bed pad 40 has a padding layer 42, a sheet layer 44 adjacent to the padding layer, and a border 45 adjacent to and extending from the surface of sheet layer 44. In the embodiment in FIG. 4b, the border 45 does not extend around the periphery of the bed pad 40 as does the border 36 in the embodiment in FIG. 3. Rather, in FIG. 4b, the border is contained within the top surface of the bed pad 40 such that portions of the sheet layer are exposed on the sides and ends of the bed pad between the border and edges or periphery of the bed pad. A border has a height of about 0.25 inches and a width of from about 0.5 inches to about 1.5 inches for example. In one embodiment, the border is a foam material. In another embodiment, the foam material of the border is adapted to collect and retain liquids within the pad. In place of foam, other liquid absorbent materials may be used. The border may be attached to the sheet layer by any suitable means including, but not limited to, the use of adhesive, stitching, sewing, stapling, and thermal bonding techniques. The border may be used to prevent any fluids from running off of the bed pad. While FIGS. 3 and 4 depict the use of a border in conjunction with a two-layer bed pad construction, the present invention also contemplates the use of a border in conjunction with a three or more layer or sandwich construction. When used with a three-layer construction, a border is usually attached to only one of the sheet layers.

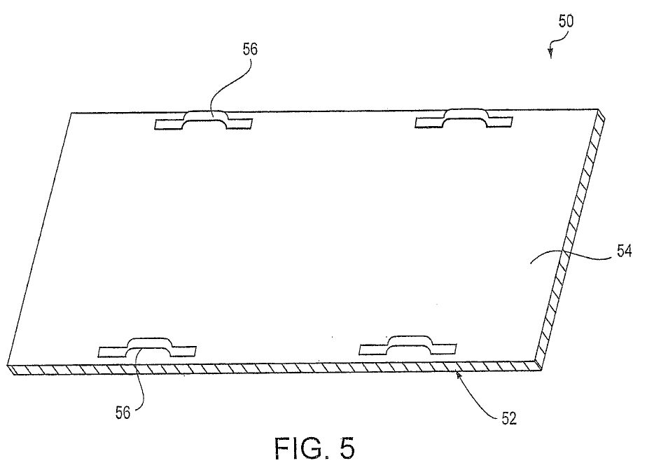

A bed pad may also include a plurality of components for gripping, grasping, or taking hold of the bed pad to facilitate moving the bed pad (and the person lying thereon). Any suitable means for gripping or taking hold of the bed pad may be included, including but not limited to holes or openings in the bed pad and/or handles. Embodiments of bed pads that include a gripping means or components are depicted in FIGS. 4a, 4b, and 5. The embodiments in FIGS. 4a and 4b show a bed pad 40 having padding layer 42 and sheet layer 44 adjacent to padding layer 42. The bed pad 40 further includes a plurality of holes or openings 48. The openings are preferably longitudinal slots 46 that are formed by portions of the bed pad which have been removed. A person may insert their hands or fingers through the openings to grasp the pad. Specifically, the slots essentially create a handle 47 on the surface of the pad in the region between the opening 48 and the edge of the pad. The holes or openings that provide a means to grasp or hold a bed pad may have any desired shape or size and are not limited to the longitudinal slots depicted in FIGS. 4a and 4b. Additionally, the number of holes or openings may be chosen based on the size of the pad and/or the end user's needs.

In FIG. 5, bed pad 50 has a padding layer 52 and sheet layer 54 adjacent thereto. The pad 50 further includes a plurality of handles 56 as gripping means. As depicted in FIG. 5, the handles are strap handles made from a flexible and/or manipulable material. The straps may be formed from any flexible material that is sufficiently strong enough such that the strap will not break during lifting. Non-limiting examples of suitable materials for a strap include nylon or nylon products (e.g., woven nylon materials). In the case of a strap handle, the handle is created by attaching the ends of the material to the bed pad, such that a portion of the strap between the ends of the straps (that have been attached to the bed pad) is not attached to the bed pad. The unattached portion of the strap, when manipulated, provides a space between the surface of the bed pad and the underside of the strap through which a person may insert their fingers to take hold of the strap. Retention straps may also be used as the handle. Alternatively, the handles may be made from more rigid materials, including but not limited to plastics, metals or the like. The handles may be permanently attached to or detachable from the bed pad. Where a handle is made from a rigid material, it may be desirable to place some type of soft padding material around the handle. The use of such material would provide comfort to personnel handling the pad and also protect persons lying on the pad from the hard, rigid handles. As with the use of holes or openings for the means to grasp the pad, there is no limit with respect to the size, shape, or quantity of handles used on a bed pad. Further, the location of the plurality means to grasp the bed is not limited in any manner. Additionally, combinations of gripping means may be provided on the pad; e.g., a pad may provide both openings in the pad as gripping means for hands and nylon straps through which poles may be run to turn the bed pad into a stretcher. Preferably the gripping means are located to provide for sufficient, uniform support of the person when the pad is lifted or moved.

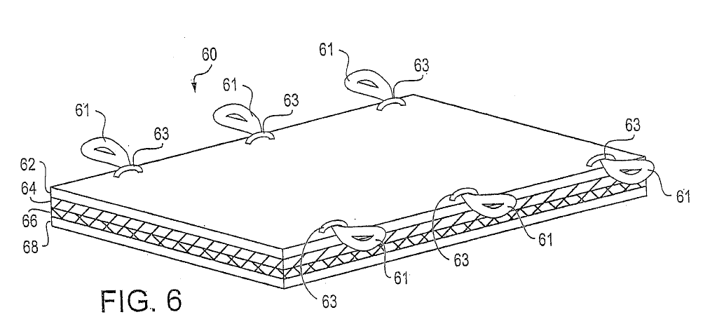

In FIG. 6, the bed pad 60 is a four-layer laminate or sandwich construction comprising a padding layer 64 adjacent to a strength-promoting layer 66. Adjacent to the padding layer 64 is a first sheet layer 62 and adjacent to the strength-promoting layer 66 is a second sheet layer 68. A number of straps 61 which are fastened to the bed pad 60 by fastening means 63 are provided along opposite sides running the length of the bed pad 60. In this embodiment, two poles may be run through the straps to form a stretcher. Although FIG. 6 is depicted as having six straps, there is no limit with respect to the size, shape, quantity, or the location of straps used on the bed pad.

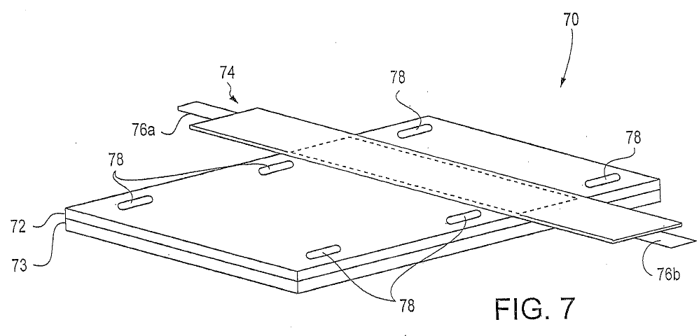

FIG. 7 illustrates a bed pad 70 with drapes. The drapes can serve to hold or otherwise retain a person's arms within the dimensions of the bed pad to prevent them from being injured and/or impeding personnel who are moving the bed pad. In FIG. 7, the bed pad 70 is a two-layer construction comprising a padding layer 73 and a sheet layer 72. Gripping means 78 are provided preferably along two or more sides or regions of the pad 70. Drapes 74 are integrally attached to the sheet layer 72. The drapes 74 are shown with optional complementary fasteners 76a and 76b. For example, in FIG. 7, 76a is the hook portion of a Velcro strap and 76b is the loop portion of a Velcro strap. Other fasteners may be used, e.g. zippers, a clasp and slot, button and buttonhole, etc. One or more drapes may be utilized in conjunction with the bed pad. For example, a single drape may be utilized which is attached to and extends from one side or region of the bed pad. Alternately, two or more drapes may be used. The drapes can be either releasably or permanently attached to the bed pad.

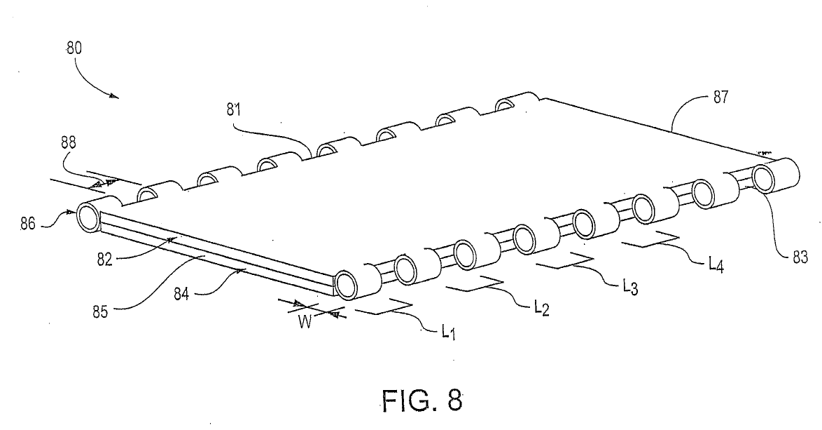

FIG. 8 illustrates a bed pad 80 with a plurality of outwardly extending tabs that can serve as hinges or as interlocking members. The bed pad includes a plurality of these tabs, each tab preferably defining an aperture adapted to receive a support member such as a pole, described in greater detail herein. The bed pad 80 is a two-layer or laminate construction comprising a padding layer 84 and a sheet layer 82, although additional layers may be utilized. Tabs are located along the sides 81 and 83. The ends 85 and 87 are shown as generally straight and extending parallel to each other; however, they may also exhibit different forms such as being arcuate or curved. A hinge 86 is created by removing part of a side or end of the bed pad 80 to create a tab and a void 88. The tab is then folded back upon itself and the outer edge of the tab is heat sealed or heat bonded to the main body of the bed pad to create a hinge of diameter W. The resulting hinge is a cylindrical opening that is an integral part of the bed pad and operates as a door hinge. Rigid poles can be inserted through these hinges, e.g. for a stretcher. Preferably, the hinge has no exposed edges which might fray and reduce the operating life of the bed pad. The tab comprising or forming each hinge is preferably cut out of both the sheet layer (or layers) and the padding layer so that the hinge is the same thickness as the rest of the bed pad. In this illustration, the outer edge of the tab is heat bonded to the padding layer; however, this is not a requirement. For example, in the case of a three-layer construction comprising a padding layer and two sheet layers, the outer edge of the tab may be heat bonded to one of the sheet layers. While depicted as having eight hinges on the sides 81 and 83 of the bed pad, there is no limit as to the number of hinges or their location. In FIG. 8, the length of a hinge is shown as L, and the length of a void is shown as L₂. L, and L₂ can vary independently, but are preferably the same length. In one embodiment, both L, and L₂ are about 3 inches. The diameter of each hinge W is independent with respect to L, and L₂. It should be noted that the length of each hinge may independently differ from the length of another hinge. For example, L, and L₃ are lengths of different hinges; L, may be 4 inches while L₃ is 3 inches. The length of each void may also independently differ from the length of another void. L₂ and L₄ may be different lengths.

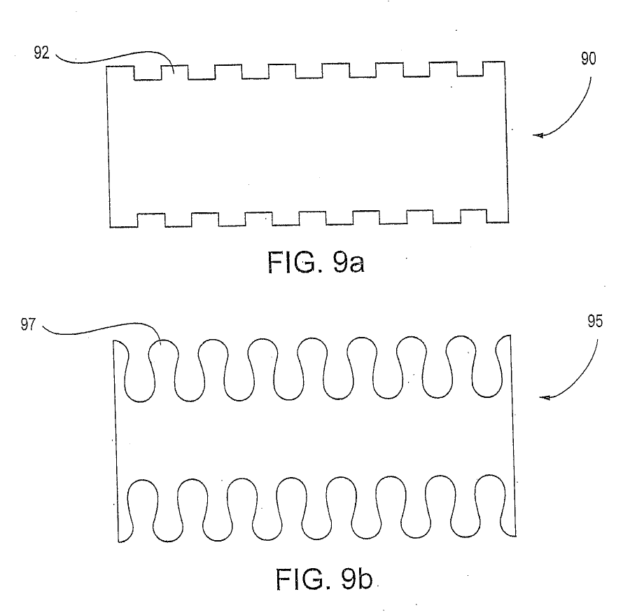

FIGS. 9a and 9b are planar top views of bed pads 90 and 95. These figures show that there is no limit as to the shape of the tabs. In FIG. 9a, the tabs 92 are square or rectangular. In FIG. 9b, the tabs 97 are arcuate or “puzzle cut”. The shape of the tab may be determined for aesthetic or practical reasons. For example, a puzzle cut tab would aid in joining two separate bed pads and holding them together without the use of an external aid (such as a rigid pole).

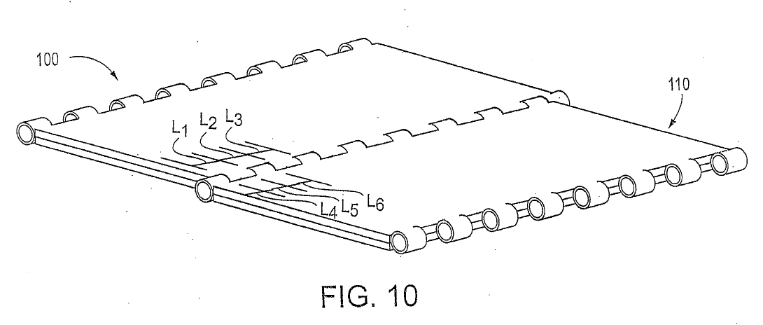

FIG. 10 is another embodiment of a bed pad assembly. Two bed pads 100 and 110, not necessarily identical to each other, are shown positioned in the same plane relative to each other. They are offset from each other by the length of one tab and laid together with the tabs of one pad fitting into the voids of the other pad. When positioned in this fashion, the two pads may be further connected and secured together by inserting a rigid pole through the tabs though this is not required. Each bed pad 100 and 110 is generally shown in FIG. 8, though the lengths and widths of each bed pad and their tabs and voids may vary independently. Although the two bed pads are depicted as laid side-by-side, this is not required. In one embodiment, bed pad 100 has tabs along its sides and bed pad 110 has tabs along its ends. They may still be laid next to each other with the tabs of each pad fitting into the voids of the other pad. The tabs do not need to fit tightly into the voids of the other pad. In this illustration, L, and L₃ are the lengths of two tabs on bed pad 100 and L₂ is the length of the void between them. Similarly, L₄ and L₆ are the lengths of two hinges on bed pad 110 and L₅ is the length of the void between them. When L,=L₂=L₃=L₄=L₅=L₆, the tab of length L, fits into the void of length L₅ and the tab of length L₆ fits into the void of length L₂. However, in another embodiment where L₁=L₃=L₄=L₆ and L₂=L₅ and L₁<L₂, the tabs would still fit within the void, but would have some “play” where they could move back and forth within the void. For example, in one embodiment where L₁=L₃=L₄=L₆=2 inches and L₂=L₅=4 inches, there would be 2 inches of movement between the two bed pads.

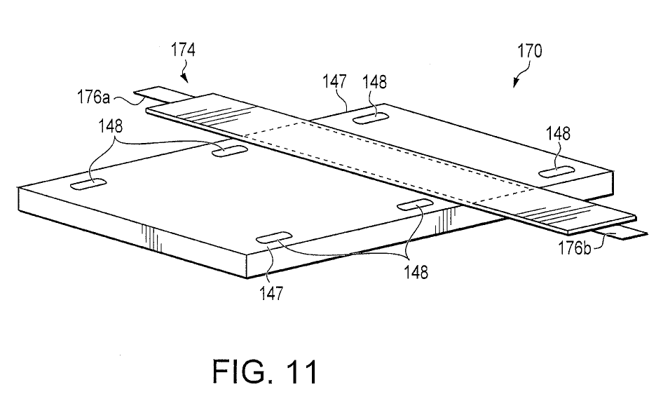

FIG. 11 illustrates another preferred embodiment bed pad 170. The pad 170 includes drapes 174 having optional complementary fasteners 176a and 176b. Other fasteners may be used. One or more drapes may be utilized in conjunction with the bed pad. The drapes can be either releasably or permanently attached to the bed pad. The bed pad 170 also includes a plurality of holes or openings 148. The openings are preferably longitudinal slots that are formed by portions of the bed pad which have been removed. A person may insert their hands or fingers through the openings to grasp the pad. Specifically, the slots essentially create a handle 147 on the surface of the pad in the region between the opening 148 and the edge of the pad. The holes or openings that provide a means to grasp or hold a pad may have any desired shape or size and are not limited to the longitudinal slots depicted in FIG. 11. Additionally, the number of holes or openings may be chosen based on the size of the pad and/or the end user's needs.

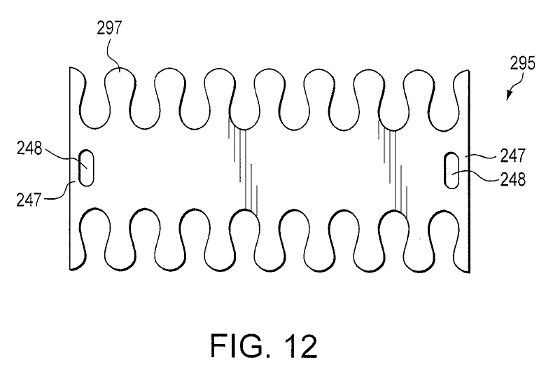

FIG. 12 illustrates another preferred embodiment bed pad 295. The pad 295 includes a plurality of tabs 297. There is no limit as to the shape of the tabs. The tabs may be square, rectangular, arcuate, or “puzzle cut” for example. The shape of the tab may be determined for aesthetic or practical reasons. The bed pad 295 also includes a plurality of holes or openings 248. The openings are preferably longitudinal slots that are formed by portions of the bed pad which have been removed. A person may insert their hands or fingers through the openings to grasp the pad. Specifically, the slots essentially create a handle 247 on the surface of the pad in the region between the opening 248 and the edge of the pad. The holes or openings that provide a means to grasp or hold a pad may have any desired shape or size and are not limited to the longitudinal slots depicted in FIG. 12. Additionally, the number of holes or openings may be chosen based on the size of the pad and/or the end user's needs.

In other embodiments, the present invention provides pads that are uniquely well suited for use as transfer pads and/or as stretchers. These multi-layer assemblies have relatively high surface area to thickness ratios. These relatively thin pads exhibit high strength properties and excellent liquid retention characteristics. These pads also exhibit remarkable resistance to abrasion and wear. In certain versions, these pads include handles, have certain width to length ratios, and are particularly designed for easy use and compact storage.

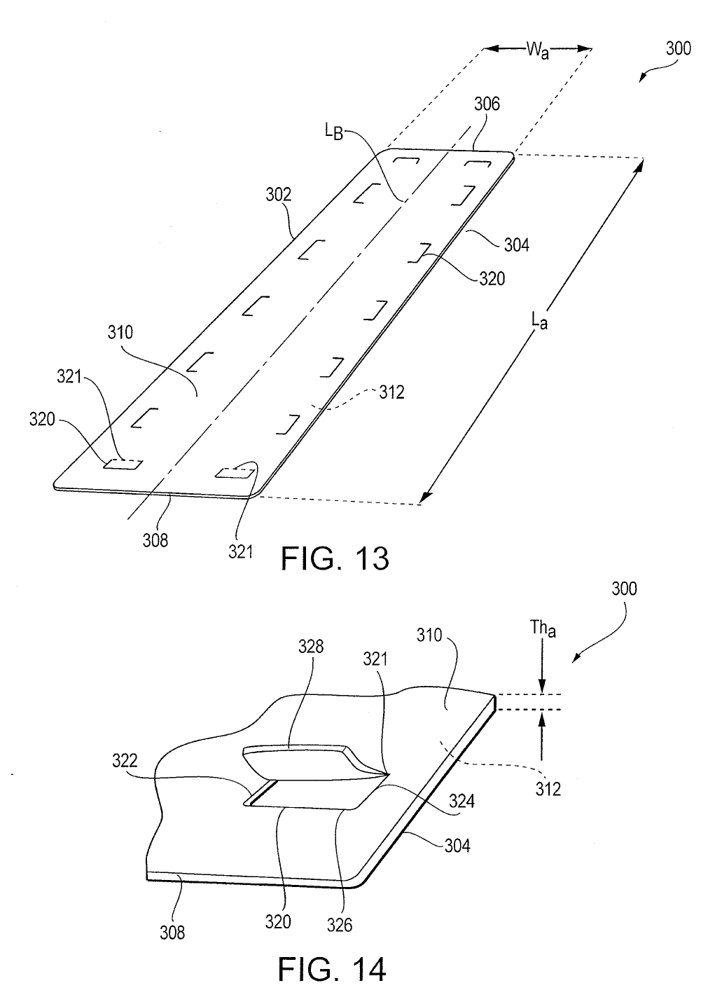

FIG. 13 is a perspective view of another preferred embodiment pad 300 according to the present invention. In this embodiment, the pad 300 defines first and second longitudinal edges 302 and 304, respectively. Extending between the edges 302 and 304 is another edge 306. Edge 308 also extends between the edges 302 and 304 and is generally opposite the edge 306. The pad 300 also defines a first face 310 and an oppositely directed second face 312. The pad 300 also preferably defines a plurality of hand holds around the outer periphery or outer peripheral region of the pad 300, each hand hold preferably formed by a U-shaped incision 320.

FIG. 14 illustrates a corner of the pad 300 depicted in FIG. 13 showing the preferred hand hold in greater detail. The preferred hand hold comprises a flap 328 that results from folding or otherwise displacing pad material resulting from the incision 320 about a fold line 321. Specifically, each incision 320 includes a first cut portion 322, a second cut portion 324, and a third cut portion 326 generally extending between corresponding ends of the cut portions 322 and 324. The fold line 321 extends between the other corresponding ends of the cut portions 322 and 324. It will be appreciated that the present invention includes a wide array of other shapes and configurations for the hand holds and the incisions.

The preferred embodiment pad 300 includes a plurality of handles such as the noted hand holds formed by incisions 320. Preferably, the number of hand holds or handles ranges from about 4 to about 20, more preferably from about 8 to about 16, and preferably about 14. Preferably, when using 14 hand holds, 5 are provided along each longitudinal edge and 2 are provided along each end as shown in FIG. 13. The hand holds are preferably equally spaced or substantially so from one another, although such is not required. The handles, or hand holds as shown in FIG. 13, are also preferably defined in a generally symmetrical arrangement around the outer periphery of the pad, and preferably with respect to a longitudinal center line LB extending along a length dimension of the pad 300. The present invention is not limited to the particular number and arrangements of hand holds or handles described and shown with respect to pad 300. A wide array of other arrangements and configurations can be used.

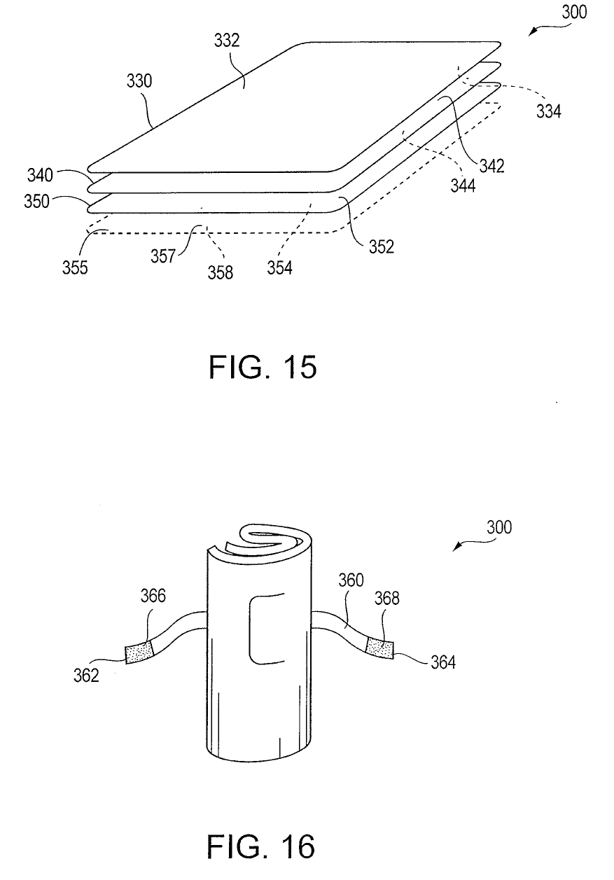

FIG. 15 is a schematic exploded view illustrating a preferred combination and arrangement of layers used in the preferred embodiment pad 300. The pad 300 comprises a sheet layer 330 that serves as a barrier layer having a first face 332 and an oppositely directed second face 334. The sheet and padding layers of the preferred embodiment pads exhibit a particular combination of properties. The barrier layer 330 of the pad 300 provides abrasion resistance among other desirable properties. For example, as described in various testing results presented later herein, pads carrying loads of 250 pounds were dragged over pavement for distances of 100 yards without causing any ruptures or areas of wear-through in the barrier layer 330. The pad 300 also comprises an adhesive scrim layer 340 having a first face 342 and an oppositely directed second face 344. And, the pad 300 comprises a padding layer 350 having characteristics such that it is absorbent, strong, and promotes comfort. The padding layer 350 defines a first face 352 and an oppositely directed second face 354. The pad 300 may also optionally comprise a second sheet or barrier layer 355 having first and second faces 357 and 358, respectively. When using a second sheet layer 355 it is preferred to use a layer of an adhesive (not shown) such as the adhesive scrim layer 340 disposed between the layer 355 and the padding layer 350. It is also preferred that one or more anti-microbial agents be incorporated in one or more layers of the pad 300.

The absorbency characteristics of the padding layer 350 are such that the pad 300 readily absorbs and retains liquids. For example, for the pad 300 having preferred dimensions of about 22.5 inches by 72 inches, such a pad can absorb and retain at least about 40 ounces of fluid, more preferably at least about 50 ounces of fluid, and typically at least about 56 ounces of fluid. This characteristic is described in greater detail herein in various testing that was performed.

The strength characteristics of the padding layer 350 are such that the pad 300 can support relatively large loads before tearing or otherwise rupturing. For instance, for the pad 300 having dimensions of about 22.5 inches by 72 inches, the lift capacity is at least 500 pounds for a pad having only four handles. Typically, increasing the number of handles significantly increases the weight or load bearing capacity of the bed pad. For the pad 300 of dimensions 22.5 inches by 72 inches having a total of six handles, the weight capacity is doubled to about 1000 pounds. This characteristic is also described in various testing reported herein. The comfort-promoting characteristic is such that the padding layer 350 provides cushioning and a soft feel to a user, and particularly to a user's skin when contacting the face 354 of the layer 350.

FIG. 16 illustrates the preferred embodiment pad 300 in a folded or otherwise compacted state. The pad 300 can be readily compacted to a folded and rolled shape having a diameter of about 4 inches and a length of about 12 inches. This is a remarkably compact and small shape. The preferred embodiment pad 300 having a most preferred size of about 22.5 inches by 72 inches, weighs only approximately one pound. It will be appreciated that such light weight is desirable, particularly for applications in which the pad 300 is carried by an individual. The pad 300 may also optionally comprise one or more straps 360 for wrapping about the pad 30b when in such compact state. The straps 360 may include regions 366, 368 of hook and loop material commonly available under the designation of “Velcro,” preferably provided at or near ends 362 and 364 of the straps 360. Thus, once the pad 300 is folded and rolled into this compact state, the straps 360 are positioned around the exterior of the compacted pad and engaged to one another.

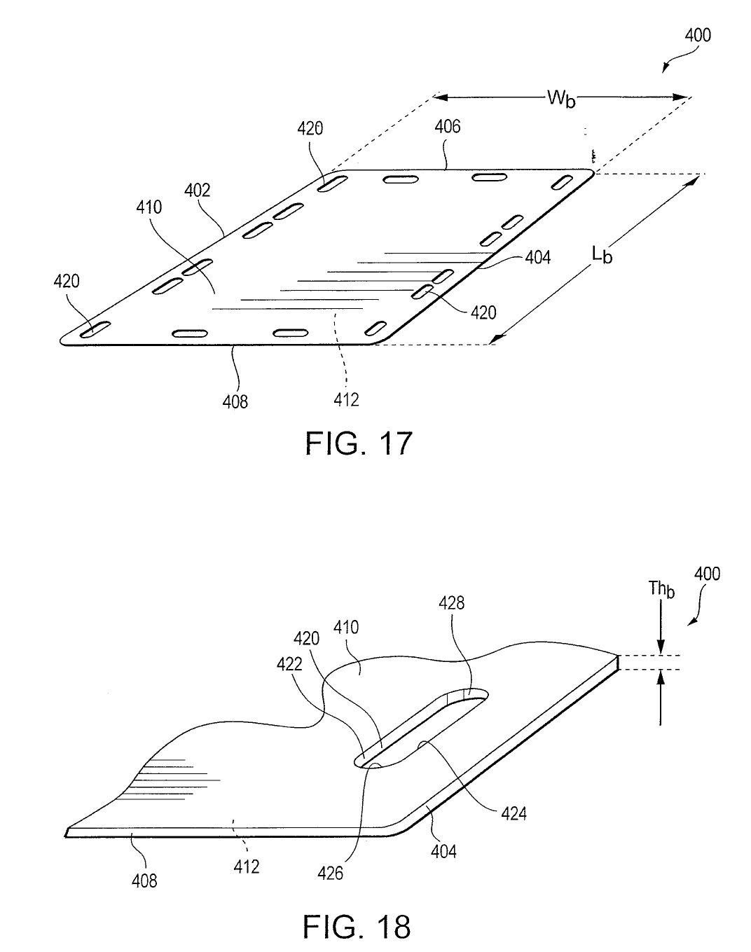

FIG. 17 illustrates another preferred embodiment pad 400 according to the present invention. The preferred pad 400 defines two opposite longitudinal edges 402 and 404, and two edges generally extending along a width dimension, 406 and 408, between the edges 402 and 404. The pad 400 defines a first face 410 and an oppositely directed second face 412. Defined around the outer periphery or outer peripheral region of the pad 400 is a plurality of hand holds or handles 420. The hand holds of pad 400 are preferably in the form of rectangular or oval-shaped apertures, and most preferably, apertures having two parallel straight longitudinal edges connected by two arcuate edges.

FIG. 18 illustrates a hand hold 420 along a corner of the pad 400 in greater detail. Preferably, the hand hold 420 is defined by a first longitudinal edge 422, a longitudinal second edge 424, opposite thereto, and third and fourth arcuate end edges 426 and 428 extending therebetween. Although a wide array of shapes and configurations can be used for the hand holds 420, it is preferred that the hand hold 420 include linear or straight edges 422 and 424 parallel to one another, and arcuate end edges 426 and 428.

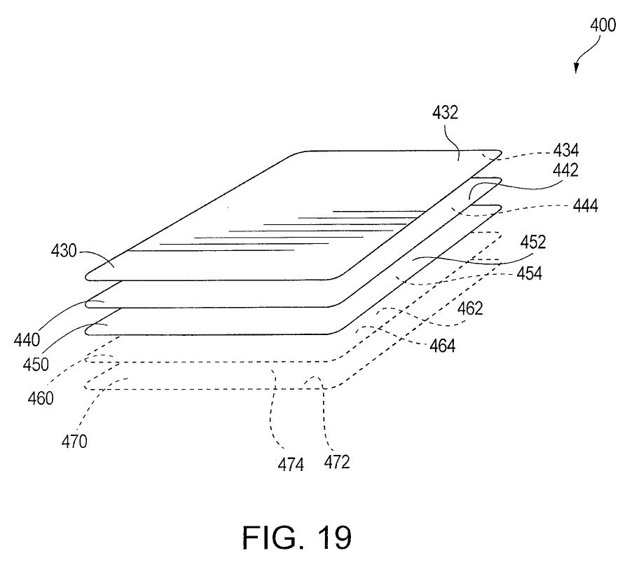

FIG. 19 is a schematic exploded view illustrating a preferred combination and arrangement of layers used in the preferred embodiment pad 400. The pad 400 comprises a sheet layer 430 that serves as a barrier layer having a first face 432 and an oppositely directed second face 434. The barrier layer 430 of the pad 400 provides abrasion resistance, among other desirable properties as previously described with regard to the preferred embodiment pad 300. The pad 400 also comprises an adhesive scrim layer 440 having a first face 442 and an oppositely directed second face 444. The pad 400 also comprises a padding layer 450 having a first face 452 and an oppositely directed second face 454. The padding layer used in the pad 400 exhibits characteristics such as fluid absorbency, fluid retention, strength, and comfort promoting characteristics. The fluid absorbency characteristics are also described in greater detail herein under the description of testing. The strength characteristics are described in greater detail herein in the noted testing. The pad 400 may further optionally comprise a second layer of an adhesive scrim layer 460 defining a first face 462 and an oppositely directed second face 464. The layer of adhesive 460 is preferably identical to the previously described layer 440. The preferred embodiment pad 400 may also optionally comprise another layer or rather a second layer of a sheet layer 470 that serves as a barrier layer. The sheet layer 470 defines a first face 472 and a second oppositely directed face 474.

The dimensions of a bed pad according to the invention may vary according to the needs of the end user or the particular application. The dimensions of the bed pad may, in certain applications, generally conform to the dimensions of beds utilized in a hospital, nursing home, or other medical or patient care environment. The bed pad may also conform to the dimensions of stretchers or gurneys. In one embodiment, the bed pad has a length such that the person's entire body is capable of making contact with the pad. That is, no part of the person extends beyond or hangs off of the edges of the bed pad. In another embodiment, the bed pad has a width of from about 16 inches to about 45 inches and a length of from about 45 inches to about 84 inches. The size of the pad may also vary depending upon the use. Emergency usage pads will generally be smaller, having a width of about 24 inches and a length of about 60 inches. A large pad may also be folded to conform to smaller dimensions, i.e. folding a pad in half. The foregoing dimensions are merely exemplary and are not intended to limit the scope of the invention in any way. It is contemplated that a bed pad may have larger or smaller dimensions as desired and/or needed by an end user.

A bed pad has a thickness of from about 0.10 inches to about 2.25 inches, and preferably from about 0.125 inches to about 2 inches. In embodiments for use in a hospital, the pad may be made relatively thin, for the person to lie on. In this embodiment, the bed pad preferably has a thickness of from about 0.125 inches to about 0.375 inches and most preferably from about 0.125 inches to about 0.188 inches. The pad, however, should have a thickness sufficient to support the person during the transfer or movement of a person. In embodiments for use as a bedroll, the pad may be thicker in order to cushion the user from ground conditions such as rocks and small holes to provide greater comfort when used. In this embodiment, the bed pad preferably has a thickness of from about 1 inch to about 2 inches. However, it will be appreciated that the present invention includes pads or layered assemblies having a wide range of thicknesses.

The pads of FIGS. 13-16 are preferably formed to exhibit particular proportions of length, width, and thickness. The length Lₐ of the preferred pad 300 shown in FIGS. 13-16 is from about 66 to about 78 inches, more preferably from about 69 to 75 inches, and most preferably about 72 inches in length, Lₐ. The width Wₐ of the preferred pad 300 is from about 18 to about 26 inches, more preferably from about 20 to about 24 inches, and most preferably about 22.5 inches. The proportions of width to length, i.e. Wₐ to Lₐ for the preferred pad 300 are from about 23% to about 40%, more preferably from about 27% to about 35%, and most preferably about 31%. For the noted pads with handles, these proportions have been found to be desirable in terms of use of the pad and overall aesthetics.

The pads of FIGS. 17-19 are preferably formed to exhibit particular dimensions and/or proportions of length, width, and thickness. The length L_{b} of the preferred pad 400 shown in FIG. 17 is from about 66 to about 78 inches, more preferably from about 69 to 75 inches, and most preferably about 71.5 inches in length, L_{b}. The width W_{b} of the preferred pad 400 is from about 36 to about 52 inches, more preferably from about 40 to about 48 inches, and most preferably about 44.5 inches. The proportions of width to length, i.e. W_{b} to L_{b} for the preferred pad 400 are from about 46% to about 79%, more preferably from about 53% to about 70%, and most preferably about 62%. As with the previously described pads, these proportions have been found to be desirable with regard to use of the pad and overall aesthetics of the pad.

The preferred embodiment pads exhibit relatively large ratios of surface area, i.e. as measured by one face of the pad, to thickness. For example, for the preferred embodiment pad depicted in FIGS. 13-16, for a pad having a surface area of 1620 square inches, such as resulting from the pad having dimensions of 22.5 inches by 72 inches, and a thickness Thₐ (FIG. 14) of 0.125 inch, the ratio of surface area to thickness is about 12,960:1. Similarly, for the preferred embodiment pad depicted in FIGS. 17-19, having a surface area of 3182 square inches for example, such as resulting from the pad having dimensions of 44.5 inches by 71.5 inches, and a thickness Th_{b} (FIG. 18) of 0.125 inch, the ratio of surface area to thickness is about 25,456:1. Accordingly, many of the preferred embodiment pads exhibit a ratio of surface area to thickness of from about 800:1 to about 50,000:1, more preferably from about 2,000:1 to about 40,000:1, more preferably from about 6,000:1 to about 35,000:1 and most preferably from about 10,000:1 to about 26,000:1.

Many of the preferred embodiment pads also exhibit relatively high strength characteristics. As previously noted, current fabrics used in conventional military stretchers often fail when subjected to loads of about 200 pounds. The preferred embodiment pads can, in certain versions, exhibility high strength characteristics such that the pads can be suspended or otherwise held above the ground and loaded with a large amount of weight, without the pad ripping, tearing, or otherwise rupturing. This desirable high strength feature is demonstrated in the results of testing presented herein. Preferably, certain embodiments of the present invention pads can support loads of at least 250 pounds, more preferably at least 300 pounds, more preferably, at least 400 pounds, more preferably at least 500 pounds, more preferably at least 600 pounds, more preferably at least 700 pounds, more preferably at least 800 pounds, more preferably at least 900 pounds, more preferably at least 1,000 pounds, and most preferably at least 1,100 pounds without ripping, tearing, or otherwise rupturing. Although the upper strength limit of the present invention pads has not been quantified, it is contemplated that certain embodiments may be able to support loads as high as 2,000 pounds or more without the pad ripping, tearing, rupturing, or otherwise failing.

Many of the preferred embodiment pads according to the present invention exhibit relatively high fluid absorption and fluid retention characteristics. The high fluid absorption and retention characteristics are demonstrated in the results of testing presented herein. Certain embodiments of the present invention pads can absorb and retain relatively large amounts of liquid per unit of surface area. Preferably, certain pads according to the present invention can absorb and retain about 1 ounce of liquid for every 50 square inches of surface area, i.e. as measured by one face; more preferably about 1 ounce of liquid for every 40 square inches; more preferably about 1 ounce of liquid for every 30 square inches; and most preferably 1 ounce of liquid for every 20 square inches. It is contemplated that certain pads of the present invention could be configured to absorb and retain even greater amounts of liquid.

In a particularly preferred aspect, certain pads according to the present invention exhibit these fluid absorption and fluid retention properties in combination with the previously noted high strength characteristics. Moreover, pads exhibiting these unique combinations of properties can also be formed to exhibit the relatively high ratios of surface area to thickness. It is remarkable that such relatively thin pads, i.e. having a thickness of only about 0.125 inch, can exhibit such high strength, i.e. able to support loads of 300 pounds, 400 pounds, 500 pounds, or more without failure, and also exhibit such high fluid absorption and retention characteristics, i.e. able to absorb and retain about 1 ounce of fluid for every 40 square inches, 30 square inches or less of surface area.

### Padding Layer(s)

Any suitable material may be used as the padding layer. The material should be soft and pliable enough to provide the person with a comfortable surface upon which to lie, but rigid enough such that it will adequately support the person's weight when the pad is used to move the person. Additionally, it is preferable that the material used in the padding layer is a breathable material. A non-limiting example of a material suitable for use as the padding is a 10-oz needled mat of polyethylene terephthalate (PET) fiber. Another suitable composition includes a fiber composition comprising from about 10% to about 25% of rayon, from about 30% to about 40% PET, and from about 30% to about 40% of a PET bi-component. The PET bi-component is a polymer containing PET and a polyolefin. Any polyolefin may be used in the PET bi-component, including but not limited to olefins having 2-30 carbon atoms. Particularly suitable (poly)olefins include polyolefins of ethylene, propylene, butene, pentene, hexene, heptene, octene, nonene, decene, undecene, and dodecene. A particularly preferred polyolefin is polyethylene. Another suitable composition used to form the padding layer is a fiber composition comprising from about 60% to about 80% PET and from about 20% to about 40% Rayon. Additionally, cotton may be added to the fiber compositions in minor amounts to make the pad softer if desired. Cotton may be added in amounts of up to about 25% of the composition. In forming the padding layer, it is desirable to needle or entangle the fibers in order to increase the strength of the padding layer. It is also preferable that the padding layer exhibit antimicrobial properties. The padding layer may be treated with an antimicrobial component after the pad is formed. Preferably, an antimicrobial agent or material is included in the fiber composition. An antimicrobial component may be added to the fiber composition in from about 10% to about 25% by weight of the fiber composition. Preferably, such agent is added at a concentration of 20% by weight of the fiber composition. Any suitable antimicrobial agent or material known or used in the art may be used in the padding layer. The padding layer may be water-repellant or water-absorbent depending on the end user's needs. In the case of a two-layer construction, it may also be desirable for the padding layer to have a low coefficient of friction to facilitate easy sliding of the bed pad. Alternatively, it may be desirable for the padding layer to have a high coefficient of friction to prevent the bed pad from sliding around during normal movement. In one embodiment, the bed pad would be a two-layer construction with a high-friction padding layer and handles; the friction would prevent the bed pad from sliding while the handles would allow person transfer by easy lifting of the person (rather than sliding). The padding layer may obtain the water-repellant or water-absorbent properties and the low-friction or high-friction properties through the properties of the composition comprising the padding layer. Alternatively, coatings could be applied to the padding layer to impart the desired properties.

A preferred material for the padding layer is a layer of nonwoven 100% polyester fibers having a melting point of 250° C., flash point of 400° C., and a basis weight of from about 6 ounces per square yard to about 20 ounces per square yard, and more preferably from about 10 ounces per square yard to about 15 ounces per square yard, and which is available from Troy LLC of Harrisville, W. Va. The material preferably comprises 80% of the noted polyester fibers and 20% of an antimicrobial additive.

In a particularly preferred aspect, the nonwoven material for use as the padding layer exhibits particular physical properties as follows. The size of the fibers is 4-8 denier, with 6 denier being preferred. The cut length of the fibers is from about 3 to about 5 inches, more preferably from 3.75 to 4.25 inches, and most preferably 4 inches. The fibers exhibit crimps, or rather small folds or ridges along their length, typically about 5 to 20 crimps per inch and preferably 10 crimps per inch. The fibers also exhibit a characteristic in which they can be elongated along their length by at least 40% and up to 60% or more, with 50% elongation being preferred. The fibers exhibit a mean tenacity of about 3 g/d to 5 g/d or more, with 4 g/d being preferred. Fibers exhibiting these combinations of properties have been found to be particularly well suited for use in the pads described herein.

Certain versions of the pads can utilize particular basis weights of the padding layer. For example, the preferred embodiment pad 300 most preferably utilizes a padding layer 350 formed from a layer of 100% polyester fibers with a basis weight of 10 ounces per square yard, available from Troy. The pad 400 most preferably utilizes a padding layer 450 formed from a layer of 100% polyester fibers with a basis weight of 15 ounces per square yard, available from Troy.

### Sheet Layer(s)

The sheet or barrier layer is preferably made of a fabric material. The fabric material is a breathable sheet. In one embodiment, the fabric is treated with a substance that renders the fabric repellant to fluids such as water, alcohol, blood and the like, so that fluids cannot flow through the sheet layer (and subsequently into the padding layer). In another embodiment, it is preferred that the sheet layer is capable of absorbing liquids or fluids. It may be desirable for the sheet layer to have a low coefficient of friction to facilitate easy sliding of the bed pad. Alternatively, it may be desirable to have a high coefficient of friction to prevent the bed pad from sliding around during normal movement. The sheet layer may obtain the water-repellant or water-absorbent properties and the low-friction or high-friction properties through the properties of the composition comprising the sheet layer. Alternatively, coatings could be applied to the sheet layer to impart the desired properties. Because the person lies on the sheet layer, the sheet layer should contain few chemicals and more preferably is hypoallergenic. It is also desirable that the fabric is capable of being sterilized by any method known in the art. Because, as discussed further herein, a bed pad in accordance with the present development may be used in place of traditional hospital beddings, it is highly desirable that the fabric material provide a suitable surface upon which a person may lie. That is, it is desirable for the fabric to provide softness and comfort comparable to traditional beddings, with the attendant advantage of being fluid repellant or absorbent and capable of being sterilized.

The sheet layer(s) used in certain preferred embodiment pads generally comprise polyethylene in the form of relatively fine fibers of polyethylene. The polyethylene fibers may also comprise one or more other components such as polyesters. Additional fiber types may be used with the noted polyethylene fibers such as polyester fibers. In other embodiment pads, the sheet layer(s) may comprise cellulose fibers such as those from wood and/or cotton. Additional fiber types can be used in combination with the cellulose fibers such as polyester fibers. In all noted sheet layer(s), binder materials such as acrylic binders may be used.

The sheet layer may have any color desired by the end user. By custom and tradition, hospital beddings typically have a blue color. Therefore, the material used to form the sheet layer of bed pads used in hospital environments can have a blue color. However, bed pads used in a military setting, e.g. stretchers and/or bedrolls, may have a different color suitable for the location where they are used, e.g. tan for deserts, camouflage for jungles, etc.

A suitable material for the sheet layer is a nonwoven fabric such as DEXTER® 7844 Drape and Gown from Ahlstrom Fiber Composites, Windsor Locks Plant, Two Elm Street, Windsor Locks, Conn. 06096-2335. Grade 7844 is a lightweight nonwoven fabric comprised of natural wood pulp or cellulose fibers, and polyester fibers bonded with an acrylic polymeric binder. The preferred basis weight for a layer of 7844 material is about 59 grams per square meter.

TABLE 1
Physical Properties of Ahlstrom 7844

| | | |
|---|---|---|
| Basis Weight | 59.4 | gsm |
| Dry Grab Tensile Strength MD | 9,400 | grams |
| Dry Grab Tensile Strength CD | 7,700 | grams |
| Dry Mullen Burst Strength | 1,900 | g/cm² |
| Suter (hydrostatic) Waterhead | 315 | mm |
| Flammability | 8 | seconds |
| Alcohol Repellency | 7 | rating |

TABLE 2
Composition of Ahlstrom 7844

| | |
|---|---|
| Nonwoven: | Wet laid |
| Nature of the fiber(s): | Cellulose, Polyester |
| Web surface treatment - Concentration | None |
| above 1%?: | |
| Binder: | Acrylic polymer |
| Additives: | Water repellant |
| Other major components: | None |
| Chemicals (in relevant concentrations) that | None |
| are in the list of hazardous constituents: | |

TABLE 3
Chemical Properties of Ahlstrom 7844

| Appearance | | Blue or green nonwoven fabric |
|---|---|---|
| (color of products as supplied): | | |
| Melting Point (melting range): | | 200-260 degrees C. polyester |
| Flammability: | | Not easily flammable |
| Autoflammability (temperature), | | 232 degrees C. cellulose, >500 |
| Autoignition Temperature: | | degrees C. polyester |
| Solubility | in water: | Insoluble |
| | in fat: | Insoluble |

In accordance with another aspect of the invention, the bed pad utilizes one or more outer sheet layers, e.g. a top layer and/or a bottom layer, that is formed from Tyvek®. One or both of these Tyvek® outer layers can constitute the previously described sheet layer(s). Tyvek® is formed by a process using continuous and very fine fibers of 100% high-density polyethylene that are randomly distributed and nondirectional. These fibers are first flash spun, then laid as a web on a moving bed before being bonded together by heat and pressure—without the use of binders, sizers or fillers. By varying both the lay-down speed and the bonding conditions, technicians can engineer the flashspun sheet to meet market needs. Preferably, Tyvek® soft structure layers(s) are utilized. Tyvek® layers are generally described herein as layers exclusively comprising non-woven or randomly distributed very fine polyethylene fibers that are bonded to one another. Although it is preferred to utilize the described layers comprising 100% polyethylene fibers, it is contemplated that the bed pads could use outer layers having compositions using from about 90% to about 99% polyethylene fibers, and particularly from about 95% to about 98% polyethylene fibers. However, for most applications, it is preferred to use such layers that comprise 100% polyethylene fibers.

Tyvek® soft structure is designed specifically for those textile applications where drape, hand, and soft feel are of prime importance. Made from very fine, high density polyethylene fibers, Tyvek® brand protective material offers all the best characteristics of paper, film and fabric in one material. This unique balance of properties, which cannot be found in any other material, makes Tyvek® lightweight yet strong; vapor-permeable, yet water-, chemical-, puncture-, tear-, and abrasion-resistant. Tyvek® is also low-linting, smooth and opaque.

Generally, a wide array of Tyvek® layers or sheets may be used in the bed pads. Preferred Tyvek® or comparable materials exhibit basis weights of from about 1 to about 3 oz/yd², with particularly preferred basis weights of from about 1.10 to about 1.20 oz/yd², from about 1.20 to about 1.30 oz/yd², and depending upon the particular application, most preferred basis weights of about 1.15 oz/yd², 1.25 oz/yd², 2.9 oz/yd², 1.74 oz/yd², 2.8 oz/yd², and from about 1.8 oz/yd² and greater. Representative thickness values for the preferred Tyvek® layers or comparable layers range from about 5 to about 20-mils, with preferred thickness values, depending upon the particular application, of about 6.3, 6.6, 10.3, and 14 mils.

Examples of particularly preferred Tyvek® soft structure materials include

Type 14 Tyvek®. Type 14 styles offer excellent wet and dry protection against particulate matter and provide an excellent barrier. High opacity and good surface stability. Tyvek® meets all the requirements of the USA Flammable Fabrics Act, CA-191-53, for wearing apparel.

It is contemplated that Type 16 Tyvek® could also be used. Type 16 Tyvek® is pin perforated with 10-15 mil (0.25 mm-0.38 mm) holes, giving it much higher air and moisture permeability, additional softness, and greater flexibility and drape than the above Type 14 style, at the expense of lower tear strength and barrier properties. Higher quality and more durable than standard nonwovens when used inside sofa and chair cushions.

Types 14 and 16 are “soft,” pointbonded products with an embossed pattern, providing a fabric-like flexible substrate with good printability and tear resistance. Type 14 styles are used where barrier and durability are required. Type 14 styles offer excellent wet and dry protection against particulate matter and provide an excellent bacterial barrier. 1422R & 1443R are acid free, lint free, tear resistant, water resistant, and breathable.

Type 16 styles are pin perforated with 10-15 mil (0.25-0.38 mm) holes, giving them much higher air and moisture permeability, additional softness, and greater flexibility and drape than Type 14 styles, but at the expense of lower tear strength and barrier properties. Type 16 styles are also available as acid and lint free.

TABLE 4
Tyvek ® Soft Structure
Technical Specifications

| | 1422R | | 1443R | | 1622E | | Test Method |
|---|---|---|---|---|---|---|---|
| Basis weight, oz/yd² | 1.15 | (Avg. 1.10-1.20) | 1.25 | (Avg. 1.20-1.30) | 1.15 | (Avg. 1.10-1.20) | ASTM D3776 |
| Strip tensile (MD), lbs/in | 7.5 | (5.2-9.8) | 8.5 | (5.9-11.1) | 7.3 | (5.0-9.6) | ASTM D1117 |
| Strip tensile (XD), lbs/in | 9.0 | (6.7-11.3) | 10.5 | (7.9-13.1) | 9.0 | (6.7-11.3) | ASTM D1117 |
| Tongue tear (MD&XD), | 2.4 | (1.4-3.4) | 2.7 | (1.7-3.7) | 1.8 | (1.0-2.6) | ASTM D2261 |
| lbs. | | | | | | | |
| Air permeability, Frazier | N/A | | N/A | | 40 | (27-53) | ASTM D737 |
| ft³/ft-min. | | | | | | | |
| Electrical resistivity, log R | 7.8 | (7.0-8.6) | 7.8 | (7.0-8.6) | 7.8 | (7.0-8.6) | AATCC 76 |

Other Tyvek® grades are contemplated for use in the present invention bed pads, include but are not limited to UV soft structures that can include 1460 UV, Reflektra™, Supra™, Plus™, and combinations of these grades.

1460 UV 1.74 oz/yd² is used for applications that need protection from harmful ultra-violet sunlight. As with all Tyvek®, it keeps water out and allows trapped water to evaporate preventing mildew. 1460 keeps out acid rain, bird droppings, soot, debris, pollen, and other forms of environmental pollution. It filters out 98% of dust particles in the 2-micron diameter range. This grade is inert to acids and bases as well as other chemicals, 1460 is oleophilic and absorbs oils and greases with little penetration. In the sun, 1460 keeps the temperature of what it is covering lower than other products. This grade stores compactly when not in use. 1460 is the base substrate for styles Reflektra™, Supra™ and Plus™.

Reflektra™ UV 1.74 oz/yd² is vacuum metalized with aluminum. Reflektra™ offers superior heat protection—boasting a 40% greater capacity to reflect heat compared to styles 1460, Plus™ and Supra™. Brilliantly reflective and lightweight, Reflektra™ has all the qualities as the above style 1460. Reflektra™ is a high-performance outdoor cover. This grade stores compactly.

Supra™ UV 2.8 oz/yd² is a bi-laminate structure designed to provide exceptional protection. Supra™ is type 1460 with a skeletal reinforced scrim. Providing the same outstanding protection from the elements as the above two styles, Supra™ is heavier, less supple, and should be used where extra strength is necessary.

Plus™ UV 2.9 oz/yd² is a bi-laminate structure comprised of type 1460 laminated to a soft non-woven inner lining. This inner lining, made of flashspun high density polyethylene and polypropylene, offers excellent protection from the elements while providing a soft, somewhat cushiony inside surface for added protection.

TABLE 5
Tyvek@ UV Soft Structure
Technical Specifications

| | |
|---|---|
| Test Method | Average Value |

PLUS ™

| | | | |
|---|---|---|---|
| Strength | | | |
| Tensile Strength | Grab Tensile (ASTM D1682) | 40/50 | lbf. MD/CD |
| Bursting Strength | Mullen Burst (ASTM D774) | 90 | psi |
| Tear Resistance | Trap Tear (ASTM D1117) | 9/8 | lbf. MD/CD |
| Barrier | | | |
| Filtration | Pore Size ASTM F-316 | 2-15 | microns |
| Water Resistance | Hydrostatic Heat (AATCC 127) | >50 | inches without penetration |
| Dimensional | | | |
| Basis Weight | ASTM D-1777 | 2.9 | oz/yd³ |
| Thickness | TAPPI T-410 | 14 | mils |
| Breathability | | | |
| Water Vapor Transmission | (ASTM E-96 Method B) | >800 | g/m² - 24 hrs. |

| Durability | | |
|---|---|---|
| UV | Natural Exposure @ 700 Mi/m² | Maintains approximately 50% of |
| | (Appx. 2 years worst case | Tensile Strength |
| | exposure) | |
| | Testing Method | Average Value |

1460

| | | | |
|---|---|---|---|
| Strength | | | |
| Tensile Strength | Grab Tensile (ASTM D1682) | 30/40 | ibf. MD/CD |
| Bursting Strength | Mullen Burst (ASTM D774) | 85 | psi |
| Tear Resistance | Trap Tear (ASTM D1117) | 9/6 | ibf. MD/CD |
| Barrier | | | |
| Filtration | Pore Size ASTM F-316 | 2-15 | microns |
| Water Resistance | Hydrostatic Heat (AATCC 127) | >50 | inches w/out penetration |
| Dimensional | | | |
| Basis Weight | ASTM D-1777 | 1.74 | oz/yd² |
| Thickness | TAPPIT-410 | >6.6 | mils |
| Breathability | | | |
| Water Vapor Transmission | (ASTM E-96 Method B) | >800 | g/m² 24 hours |

| | | |
|---|---|---|
| Durability | | |
| UV | Natural Exposure @ 700 Mi/m² (2 | Maintains approximately 50% of |
| | years extreme worst case | Tensile Strength |
| | exposure) | |

SUPRA ™

| | | | |
|---|---|---|---|
| Strength | | | |
| Tensile Strength | Grab Tensile (ASTM D1682) | 91/14 | lbf. MD/CD |
| Elasticity | % Elongation to Break (ASTM D | 14/17% | MD/CD |
| | 882) | | |
| Toughness | Work to Break (AST D882) | 17/22 | in-lbf. |
| Bursting Strength | Mullen Burst (ASTM D774) | 137 | psi. |
| Tear Resistance | Trap Tear (ASTM D117) | 22/14 | lbf. MD/CD |
| Barrier | | | |
| Filtration | Pore Size ASTM F-316 | 2-15 | Microns |
| Water Resistance | Hydrostatic Heat (AATCC 127) | >50 | inches w/out penetration |
| Water Vapor Transmission | ASTM E-96 Method B | 587 | g/m² 24 hours |

| | | |
|---|---|---|
| Durability | | |
| UV | Natural Exposure @ 840 Mi/m² (3 | 37% Reduction in Tensile |
| | years extreme worst case | |
| | exposure) | |

REFLEKTRA ™

| | | | |
|---|---|---|---|
| Strength | | | |
| Tensile Strength | Grab Tensile (ASTM D1682) | 30/40 | lbf. MD/CD |
| Bursting Strength | Mullen Burst (ASTM D774) | 75 | psi |
| Tear Resistance | Trap Tear (ASTM D1117) | 7/5 | lbf. MD/CD |
| Barrier | | | |
| Filtration | Pore Size ASTM F-316 | 2-15 | microns |
| Water Resistance | Hydrostatic Heat (AATCC 127) | >50 | inches without penetration |
| Infrared Reflectivity | D&S Emissometer | >70% | |
| Dimensional | | | |
| Basis weight | ASTM D-1777 | >1.8 | oz/yd² |
| Thickness | TAPPIT-410 | >6.3 | mils |
| Breathability | | | |
| Water Vapor Transmission | (ASTM E-96 Method B) | >550 | g/m² - 24 hrs. |

| | | |
|---|---|---|
| Durability | | |
| UV | Natural Exposure @ 700 Mi/m² (2 | Maintains 50% Tensile Strength |
| | years extreme worst case | |
| | exposure) | |

Tyvek® and its various grades are available ultimately through DuPont, and a wide array of distributors including Material Concepts of Philadelphia, Pa.

A preferred embodiment bed pad according to the present invention provides significant advantages, particularly in terms of strength and durability. Many Tyvek® layers, when incorporated in the bed pads, exhibit strengths of up to 800 pounds, yet only add approximately 2 pounds of additional weight to a 69 inch by 60 inch bed pad. The use of such Tyvek® layers for smaller bed pads is also contemplated, such as 36 inches by 60 inches. The use of a Tyvek® bottom layer can also provide significant abrasion-resistance properties to the bed pad. For example, bed pads utilizing a Tyvek® bottom layer, loaded with 200 pounds, equivalent to an average patient weight, can, in emergency situations, be dragged across asphalt or concrete surfaces for extended distances without significant damage.

Another preferred material for use as the sheet layer(s) is a layer of Suprel® commercially available from DuPont of Wilmington, Del. Suprel® is available in a wide array of different grades, however generally comprises from about 80 to about 100% of a blend of polyethylene fibers and polyester fibers. The remaining constituents of the layer(s) can comprise colorants, fillers, and other additives. A preferred grade of Suprel® for use in the preferred embodiment bed pads is Suprel® 7714, which utilizes a polyethylene/polyester blend fabric.

Certain versions of the pads can use particular types of the previously described sheet layers. For example, the preferred embodiment pad 300 most preferably utilizes a sheet layer 330 in the form of the previously described Suprel® material and specifically, Suprel® 7714. The pad 400 most preferably utilizes a sheet layer 430 in the form of the previously described material available from Ahlstrom under the designation 7844.

### Adhesive Layer(s)

In certain embodiments or versions of the present invention pads, it may be desirable to utilize one or more layers of adhesive between other layers in the layered assembly. For example, a layer of a thermally activated adhesive, for example in the form of a liquid, powder, or sheet has been found to be useful. An example of a thermally activated adhesive is a hot melt adhesive which is activated upon heating. It is preferred to use an adhesive layer to adhesively bond the padding layer to the one or more sheet layer(s), and most preferably to provide such bonding over an entire face of such layers in a uniform manner. The adhesive layer can for example be in the form of a thin layer of a thermally activated adhesive in a nonwoven form. A preferred adhesive layer is PE75 from Bostik, Inc. of Middleton, Mass., having a basis weight of from 20 grams to 70 grams per square yard. Preferably, when utilizing a layer of PE75, a layer of such material having a basis weight of 50 grams per square yard is selected. This preferred thermally activated adhesive is activated upon exposure to 190° F. (88° C.). PE75 is a polyester based web adhesive.

### Additional Aspects

It may be desirable to include a system or sensor in the bed pad(s) of the invention to monitor and/or detect when fluids are gathering or otherwise collect on the bed pad. A bed pad may include one or more sensors disposed between the sheet layer and the padding layer. In an embodiment where the sheet layer is fluid-repellant and/or impervious to the flow of fluids, sensors may be placed on the top surface of the sheet layer. Sensors may be placed at any location and are preferably located in regions likely to receive moisture. For example, in a hospital environment it is advantageous to utilize sensors in regions of the bed pad that would be expected to receive moisture from the discharge of urine or other electrolytic bodily fluids. Sensors preferably have a minimal thickness such that the flexibility and comfort of the bed pad are not compromised. Any suitable moisture detector or sensor may be used as the sensor, including but not limited to the moisture monitoring systems disclosed in U.S. Pat. No. 6,292,102 and/or U.S. Pat. No. 6,580,013, both of which are incorporated herein by reference. Employing a moisture sensor/detector system in a bed pad provides several advantages. The use of moisture sensors or detectors provides a means to notify hospital or nursing home personnel when a patient needs assistance. Sensors notify patient care personnel when a patient's bedding needs to be changed or cleaned, when a bed pad needs to be cleaned, and/or when a patient needs further care or assistance. Such systems also allow medical or patient care personnel to monitor a patient's condition (for example, whether an incontinent patient's condition is improving or not). The use of moisture detectors further allows medical personnel to record a patient's fluid activity. Recording such activity is useful to monitor the patient's condition (such as the time intervals between such activity) and to monitor the time it takes for patient care personnel to respond and provide the appropriate assistance to the patient. Thus, the use of moisture sensors in conjunction with the bed pad is advantageous and provides better patient care.

Alternatively, it may also be desirable to include a system or sensor to monitor and/or detect pressure levels. Bedsores are caused by constant pressure to the skin and muscle and/or by shearing forces and can develop in a matter of hours; prevention of this injury is highly desirable, especially in immobile patients. One or more sensors may be disposed between the sheet layer and the padding layer of the bed pad. Sensors may be placed at any location and are preferably located in regions where high pressures are likely, e.g. bony protrusions like the shoulders and buttocks. Sensors preferably have a minimal thickness such that the flexibility and comfort of the bed pad are not compromised. Any suitable pressure detector or sensor may be used as the sensor, including but not limited to the pressure monitoring system disclosed in U.S. Pat. No. 6,134,970, which is incorporated herein by reference. The use of pressure sensors may notify medical personnel of the need to move a patient so that high pressure is not applied to the same portions of the body for long periods of time. Thus, the use of pressure sensors in conjunction with the bed pad is advantageous and provides better patient care.

The optional drapes, like the sheet layer, are a single-layer material made from a breathable material, preferably a fabric material. Although a single layer is preferred, a multi-layer material may be used. They may also possess water-repellant or water-absorbent-properties and low-friction or high-friction properties. The drapes have a width of from about 12 inches to about 36 inches and a length of from about 24 inches to about 60 inches. In one embodiment, the drapes have a width of about 24 inches and a length of about 48 inches. An optional complementary fastening means may also be integrally attached to the drapes. These means include, but are not limited to, Velcro straps, button and buttonhole, clasp and slot, zippers, and other complementary fastening means known in the art. The drapes are preferably integrally attached to the sheet layer so that the length of the drapes is perpendicular to the length of the sheet layer. The drapes are placed along the length of the bed pad so that when a person is lying on the bed pad, they can be folded up around the person's arms to protect them during movement and to prevent them from impeding personnel around the bed pad. A bed pad is formed by providing a padding layer and a sheet layer and attaching the sheet layer to the padding layer. The sheet layer is attached to the padding layer by any suitable means known in the art. A preferred technique for attaching the sheet layer to the padding layer is by laminating the sheet layer to the padding layer using an adhesive such as a powdered adhesive or a sheet adhesive. If desirable, the attachment of the sheet layer to the padding layer may be reinforced by further stitching portions of the sheet layer to the padding layer. To reinforce the attachment of the sheet layer to the padding layer, such as by stitching, any portion of the sheet layer may be stitched to the padding layer. For example, the sheet layer may be stitched around the interior of the sheet layer (i.e., along each side at a given distance from the end of the sheet/pad), or the sheet may be stitched to the padding layer along one or multiple locations of either the length and/or width of the pad. The sheet layer may have the same dimensions as the padding layer, such that when the sheet layer is attached to the padding layer the peripheral edges of the padding layer are exposed. Optionally, the sheet layer may have dimensions such that the sheet layer has a length and/or width greater than the length and/or width of the padding layer. In such configurations, the ends of the sheet layer are pulled over the edges of the padding layer and attached to the underside of the padding layer (by any suitable means including, but not limited to, sewing, stitching or laminating) so that the sheet layer essentially forms a seal around the edges of the padding layer. Such a configuration may be desirable to prevent contamination of the padding layer should it come in contact with fluids that escape from the sheet layer. Encompassing the padding layer's edges with portions of the sheet layer is not necessary, however, if the padding layer includes or is treated with an antibacterial agent or material. The length and/or width of the sheet layer are never smaller than the length and/or width of the padding layer.

For the preferred embodiment pads utilizing a layer of a thermally activated adhesive, such as the pads depicted in FIGS. 13-16 and 17-19, a hot pressing operation may be used in the manufacture of those pads. For example, one or more barrier layers, a padding layer, and one or more adhesive layers are appropriately arranged and then subjected to heating and pressing. Preferably the layered assembly is brought to a temperature greater than the activation temperature of the adhesive layer, which if using PE 75 from Bostik, is 190° F. The layers are pressed together either during or after such heating. It is desirable to ensure that the temperature of the other layers does not exceed the lowest melting point of the collection of materials.

Preferably, the various pads described herein are formed as follows. The various layers are arranged as desired and as described herein. The intermediate layered array is then preferably heat laminated to bond and secure the layers together. Specifically, the thermally activated material or layer is heated to a temperature sufficient to thermally activate the material and thereby bond the padding layer(s) to the sheet layer(s).

In performing the preferred process of laminating the intermediate layered array, a commercially available laminating machine can be used, such as an Astex Model 6000. Using this device, several operating parameters have been found to produce pads with exceptional qualities. A top belt temperature of 240° F. and a bottom belt temperature of 200° F. are preferably used. A belt surface speed of 30 feet per minute is preferred. The heated and pressed pad exits the laminator having a desired thickness and density, such as for example from about 16 ounces/yd² to about 6 ounces/yd², and preferably 10 ounces/yd².

When utilizing one or more layers formed from Tyvek®, and in particular soft structure Tyvek®, the following guidelines are useful during manufacturing of the preferred embodiment bed pads.

Tyvek® can be sewn satisfactorily on any conventional sewing machine. Best results are obtained from machines equipped with puller or drop feed. Smooth, rubber-covered rolls should be used rather than knurled metal rolls which tend to leave impressions on the material. When stitching Tyvek®, use the least number of stitches per inch and the smallest needle practical for maximum resistance to tearing. Both lock stitches and chain stitches work well, especially at 1″ (2.5 cm) chain stitch which can prevent raveling. Tyvek®) can be sewn on any conventional sewing machine.

Sewing Tyvek® Type 14 and 16 (Including Styles Reflektra™ and Supra™)

Up to 12 stitches/in. (4.7 stitches/cm) can be used; however, 6-8 stitches/in. (2.4-3.1 stitches/cm) provide the highest seam strength (greatest resistance to postage stamp tear).

Use a fine-tooth feed dog—12 to 21 teeth/in. (4.7-8.3 teeth/cm).

Decrease presser-foot tension until the sheet just feeds through the machine without slipping. About 10 lb. (4.5 kg) force should be sufficient.

Decrease bobbin tension until the bobbin just slips down the thread; 3 oz. (85 g).

Wind bobbin with thread tension set so that the thread just slips through the disc; 2 oz. (57 g).

After setting bobbin tension, adjust needle tension to produce a balanced stitch.

Conventional threads of cotton/synthetic or 100% polyester maybe used.

Spun-filament polyester is stronger than cotton thread and is preferred for flame-resistant considerations.

Gluing Tyvek®

A number of adhesives can be used to glue Tyvek®), either to itself or to other substrates. In general, water-based adhesives that provide quick tack and fast drying are preferred. However, the first step in choosing an adhesive is to determine how it will react with Tyvek®. Testing a small Tyvek® sample is the best way to make this determination.

Natural-product adhesives based on starch, dextrin, casein or animal byproducts are preferred to synthetic-based adhesives. Hot animal glue is an excellent adhesive for adhering Tyvek® to paperboard.

Water-based synthetic lattices also bond Tyvek® to itself and a variety of substrates. Ethylene/vinyl acetate adhesives are especially useful, as are the acrylic pressure-sensitive adhesives. Synthetic adhesives often contain low-molecular-weight materials that can act as solvents at elevated temperatures causing swelling and wrinkling. Solvent-based single-component polyurethane adhesives provide optimum adhesion (lap and shear), flexibility and water-resistance for adhering Tyvek®) to itself, as well as a variety of substrates.

Heat Sealing Tyvek®

While it is possible to fuse Tyvek® to itself using only heat, strong seals are difficult to obtain in this way because melting the material destroys its fiber structure, reducing both flexibility and tear strength in the seal area. Non-corona-treated, non-antistated styles of Tyvek® are preferred for heat sealing Tyvek® to itself. The molecular film of oxide and antistat on the surface of corona treated/antistated Tyvek® causes a discontinuous melt to form, thus reducing the seal strength.

Trim seal dies, designed with a spring-loaded restraining plate, have been used successfully for heat sealing. However, the preferred method is to apply a coating with a melting point below that of Tyvek®, such as branched polyethylene. With such a coating, high seal strengths can be achieved using hot-bar or impulse techniques.

Tyvek®, like polyethylene film, cannot be dielectrically sealed by conventional methods. However, commercial proprietary processes have been developed that allow Tyvek® to be dielectrically sealed using conventional radio-frequency equipment. Recent developments in ultrasonic sealing have also demonstrated fiber tearing seals with most styles of Tyvek®, without the puckering that is often associated with heat seals of Tyvek®. This process also forms strong seals to a variety of plastic films and nonwovens.

The properties of the padding layer and sheet layer or other layers may be combined to provide options suiting the end user's needs. In one embodiment, the bed pad is a three-layer composition where the padding layer and one of the sheet layers are water-absorbent and the other sheet layer is water-repellant. In another embodiment, the bed pad is a three-layer composition where one of the sheet layers is high-friction and the other sheet layer is low-friction. Such options would be beneficial by allowing the bed pad to be used in multiple situations, yet requiring the end user to stock only one type of bed pad.

When an optional strength-promoting layer is included, it is placed between the padding layer and a sheet layer and attached to both layers by any suitable means known in the art. It preferably has the same dimensions as the sheet layer so that in embodiments where the dimensions of the padding layer and sheet layer are different, strength is promoted across the larger sheet layer. As noted for certain embodiments such as the pads of FIGS. 13 and 17, it may be preferred to use a padding layer that exhibits high strength characteristics.

Where a bed pad includes handles or gripping means, the handles or gripping means may be attached or formed at any appropriate time. Handles, such as for example strap handles, are preferably attached to the bed pad after the sheet layer has been attached to the padding layer. Strap handles may be attached to the pad by attaching the ends of the strap to the pad by any suitable means such as sewing, stitching, stapling, bolting, or the like. A portion of the material used for the strap remains separated, i.e., unattached, from the bed pad. The unattached portion creates the handle and allows a user to take hold of the strap. In the case of preformed handles made from a solid, rigid material, such as plastic or metal, the handles are attached to the bed pad by any suitable means, including but not limited to bolting, screwing, clamping and the like. Removable retention straps are attached to the pad by a clip. The clip may secure the strap to the pad by forming a tight connection over the top of an end of the strap and the underside of the padding layer. Alternatively, the clip may extend through an opening on the strap and through an opening extending through both the sheet layer and the padding layer. The use of a clip allows a handle to be attached to the bed pad when needed to move the person. Removable handles also allow the handles to be removed when they are not needed, such that the handles do not provide an obstruction to the person while lying on the pad. Where the gripping means are holes or openings in the pad, such as slots cut along the periphery of the bed pad, the gripping means may be formed at any time during the formation of the bed pad. For example, holes or openings may be formed in the padding layer by cutting and removing a portion of the padding layer to form the holes or openings having a desired shape. Holes or openings may then be formed on the sheet layer corresponding in location, shape and size to the openings in the padding layer. The openings may be formed in the sheet layer either before or after the sheet layer is attached to the padding layer. Alternatively, openings may be formed in a bed pad after the sheet layer has been attached to the padding layer. In the case of a bed pad having openings to provide a means to grip or hold the bed pad, the periphery of the openings may further be stitched to reinforce the attachment of the sheet layer to the padding layer and to prevent the sheet layer from fraying or pulling away from the padding layer at those locations. While the holes, openings, handles, or other gripping means may be located anywhere on the bed pad, they are preferably located where they will not contact the person lying on the bed pad in order to prevent resulting pressure differences from causing bedsores or other problems. The gripping means may also be used as fastening means. In one embodiment where the bed pad is used as a bedroll, two spandex straps can be attached at one end of the pad near each side. When the pad is rolled up, the two spandex straps can go over the ends and keep the pad tightly rolled up for convenience.

When hinges are desired, they may be formed at any time during the formation of the bed pad. For example, tabs may be formed in the padding layer by cutting and removing a portion of the padding layer to form the tabs having a desired shape. Tabs may then be formed on the sheet layer corresponding in location, shape and size to the tabs in the padding layer. The padding layer and sheet layer are then joined together as described above. Alternatively, tabs may be formed in a bed pad after the sheet layer has been attached to the padding layer. The end of each tab is then heat sealed or heat bonded to the main body of the bed pad to form a hinge. This has the advantage of producing no exposed edges, preventing fraying.

In each of the various bed pad embodiments described herein, and particularly in the pad 300 illustrated in FIG. 13, it may also be preferred to seal one or more edges of the bed pad. This is particularly desirable when utilizing dual barrier layers, each constituting an outer layer of the bed pad. For instance, referring to FIG. 15, it can in certain applications be desirable to provide the pad 300 with a first sheet or barrier layer 330 and a second sheet or barrier layer 350, and to seal the outer edges of the layered assembly. Thus, edges 302, 304, 306, and 308 are sealed or otherwise closed to preclude or at least significantly reduce the likelihood of water, moisture, or other contaminants from entering the interior of the pad 300. Such sealing can be accomplished in a variety of ways. Preferably, when utilizing the materials noted herein for the barrier layers, the edges are welded or otherwise sealed such as by known radio frequency RF welding operations.

The bed pad according to the present invention may serve as a supplemental layer of padding on the bed. The bed pad is placed on top of the mattress of a bed and provides another thin, soft layer for the person to lie on. The person is then placed on top of the bed pad according to the invention. More layers of padding may also be placed between the bed pad and the person if desired, though such layers should be smaller than the bed pad and not contain means to attach them directly to the mattress which would prevent the bed pad from fulfilling its function of providing for easy movement and/or transfer. The bed pad typically rests on top of the mattress or table. A bed pad may also include a means to further secure the bed pad to a mattress or table. For example, a bed pad may include an elastic band attached to and extending from either the sheet layer or the padding layer. Preferably an elastic band would be attached to the sheet layer. The band preferably extends around the periphery of the bed pad. An elastic band should have a sufficient width such that the band is capable of being pulled or stretched over the periphery of the mattress or table to form a tight connection between the bed pad and the mattress or table. Alternatively, a bed pad may include a material layer extending from and around the periphery of the sheet layer. The bottom of the material layer, i.e., the portion of the material layer that is furthest away from the sheet layer, preferably includes a strip of an elastic material similar to that found in traditional bed sheets. The material layer may be pulled over the mattress or table in a manner similar to traditional bed sheets. The use of such means allows a bed pad to be secured to a mattress or table to reduce the risk that the pad may slip or slide off the bed or table.

In a hospital setting, the bed pad also provides a means of adjusting a patient within the bed or for moving a person from one bed to another bed or table. Specifically, the pad is thin enough that it is easily manipulated and handled by medical personnel, but strong enough such that the entire pad may support the patient and allow for the patient to be moved by moving the pad without having to make physical contact with the person. To change the position of the patient within the bed, medical personnel may grab hold of the pad and slide the pad in the direction necessary to move the person. With respect to transferring a patient from one bed to another, personnel may grab hold of the pad and either physically lift the pad from the first bed and place it on the second bed, or slide the pad off of the first bed and onto the second bed. As previously described herein, the pad may also contain gripping means to grasp or take hold of the pad, including slots, handles, or the like. Upon grasping the pad via the gripping means, personnel may then lift and/or slide the bed pad to either change the patient's position and/or move the patient from one bed to another.

Another advantage of the bed pad embodiment utilizing lateral drapes is that in a hospital environment, once the pad is positioned on an operating table and a patient is on the pad, the drapes may be folded over or about the patient to secure the patient, and particularly, to secure the patient's arms for administration of an IV line. It is further contemplated that the bed pad could be incorporated into the upper layer of an operating table or examination table. The provision of one or more foldable drapes is believed to be of significant benefit.

The use of the bed pad according to the present invention makes patient movement more convenient and less arduous for medical personnel. It may require fewer personnel to move the patient compared to moving the patient by physically lifting, i.e., handling, the patient's body. Further, because the patient is lying on a uniform surface, the patient's limbs and extremities are not subjected to the jostling and random motion encountered in physically handling the patient. The bed pad according to the invention also has the advantage of being flexible and capable of conforming to the patient's body as compared to hard boards that are sometimes used to move a patient. The flexibility of the bed pad provides additional comfort and allows the patient to lie in a more natural position compared to a hard board.

A bed pad in accordance with the present invention may be used either in place of or in conjunction with traditional hospital beddings. First, a bed pad may be placed on a mattress as is commonly found in hospitals, nursing homes, or other patient care facilities. Such mattresses are typically capable of being adjustable so as to allow a portion of the patient's body to be positioned in an inclined and/or declined position. The thickness of the bed pad imparts flexibility to the bed pad such that the bed pad is capable of conforming to the position of the mattress. Further, the sheet layer allows a bed pad to be used in place of traditional beddings. As previously described herein, the sheet layer is comprised of a fabric material. The fabric material provides a soft surface, comparable to traditional beddings, upon which the person lies. Thus the sheet layer of the bed pad serves the same role as that of a traditional bed sheet.

The combination of certain properties of the bed pad also renders it superior to traditional beddings. The low friction of the bed pad makes it easier to transfer patients by sliding them compared to traditional bedding. Fluid-repellant properties may make the bed pad more hygienic by preventing absorption of scents and liquids into the sheet layer and the padding layer of the bed pad. Such a bed pad may also be easier to clean because it would only need to be wiped down, washed off, and sterilized; it would not need to be changed. The absorbent properties of traditional beddings may make cleaning traditional bed sheets more difficult or impossible. It may take repeated attempts in between uses of traditional beddings to completely clean the bedding, or it may not be possible to sufficiently clean the bedding for reuse. Consequently, great expense may be involved in either cleaning and/or replacing traditional hospital beddings. Thus, a bed pad according to this development, which is easily cleaned and reused, may provide significant reductions in costs associated with cleaning and/or replacing traditional beddings. Reducing the frequency with which the bedding must be changed and/or replaced also reduces the number of times that a patient needs to be moved. A bed pad is disposable and easily replaced if necessary. Preferably, a bed pad will be used only once before it is discarded. However, the ability to be reused may be desirable for at home patient care or where it is financially desirable to reuse the pads.

The bed pad according to the present invention also finds use in a military environment. When the bad pad has straps or hinges, it may be used as part of a stretcher. It can also be used as a bedroll for military personnel, recreational users, etc.

When the bed pad includes drapes, the drapes can be used to secure the person's arms within the dimensions of the bed pad itself.

### Testing

A series of investigations were conducted to further define, identify and quantify various characteristics of certain preferred embodiment bed pads according to the present invention. In particular, a series of tests were conducted relating to fluid absorbency, fluid retention, weight capacity prior to failure, and weight capacity after dragging.

### A. Fluid Absorption

Samples of a preferred embodiment pad corresponding to the pad 300 depicted in FIG. 13 were subjected to a fluid absorption test. In this test, three (3) pad samples, each measuring 12 square inches and comprising a padding layer obtained from Troy LLC, of nonwoven 100% polyester fibers having a basis weight of 10 ounces per square yard, with a sheet layer of Suprel® 7714 from DuPont, were utilized. Each sample was placed onto a sheet of dry paper which in turn was placed on a flat metal pan. The padding layer of each sample was facing upwards. A liquid dispenser having provisions to control the amount of liquid flow and flow rate was used to administer controlled amounts of fluid at specific flow rates onto each sample. A liquid having a viscosity of 3 millipascal seconds, which is comparable to the viscosity of blood (i.e. 3-4 millipascal seconds), was dispensed upon each sample at a flow rate of 4.7 liters per minute (i.e. the same flow rate as a human heart at rest). The maximum amount of fluid dispensed onto a 12 square inch sample was then determined, prior to the paper becoming wet from the dispensed fluid. An average value of 5 ounces of fluid was dispensed for each sample while maintaining the paper under the sample in a dry state. Extrapolating this degree of absorbency for a pad measuring 22.5 by 72 inches, demonstrates that such a sized pad could absorb and retain about 56 ounces of such fluid.

In another series of trials, three samples of a bed pad corresponding to the bed pad 400 illustrated in FIG. 17 were tested with regard to their fluid absorption characteristics. Three samples corresponding to the bed pad 400 having single layers of a sheet layer 430, an adhesive layer 440, and a padding layer 450 were subjected to a fluid absorption test as previously described. The samples used a padding layer obtained from Troy LLC, of nonwoven 100% polyester fibers having a basis weight of 15 ounces per square yard, with a sheet layer of Ahlstrom 7844 material. Specifically, the samples were placed onto sheets of dry paper and a liquid then dispensed onto the samples. Five (5) ounces of the previously described liquid with the noted viscosity, was administered onto each sample at a flow rate of 4.7 liters per minute. Each of the samples absorbed the liquid and prevented the liquid from wetting the paper underneath.

### B. Fluid Retention

In another series of tests, a 12 square inch sample of a pad corresponding to the preferred embodiment pad 300 using the previously noted padding layer with 10 ounce basis weight with a sheet layer of Suprel® 7714, was drag tested as described herein under section D. After dragging, the same fluid as used in the fluid absorption test described under section A was administered onto the sample pad. The sample was positioned on dry paper on a flat metal pan as previously described. A total of 5 ounces was dispensed at a flow rate of 4.7 liters per minute. After dispensing of the liquid, the time period was measured until the liquid soaked through the sample and transferred onto the dry paper. A total of two (2) minutes were required until the liquid had penetrated and soaked through the sample and wetted the paper.

### C. Weight Capacity Prior to Failure

In this series of tests, two bed pads each corresponding to the preferred bed pad 300 illustrated in FIG. 13 were provided. The samples utilized the previously noted padding layer with 10 ounce basis weight with a sheet layer of Suprel® 7714. A steel rectangular frame having dimensions slightly larger than those of each tested bed pad was suspended several feet from the floor by a vertical lift assembly. The first pad tested was attached to the frame by a total of four (4) straps. Each strap was extended through a hand hold defined along the periphery of the bed pad. The four hand holds of the fourteen defined in the bed pad were selected so as to equally (or approximately so) space the straps from another. Fifty (50) pounds bags were then incrementally placed upon the bed pad. The bed pad supported by four straps through 4 hand holds, held 500 pounds. Additional bags were added until failure clearly occurred at 600 pounds. This testing demonstrated that the pads according to the embodiment illustrated in FIG. 13 supported loads of 500 pounds without ripping, tearing, or otherwise rupturing.

In another trial, the second sample was retained to the frame by a total of six (6) straps extending through six hand holds. The pad was attached to the frame by the six straps equally (or approximately so) spaced from one another. The sample supported a load of 1,000 pounds without ripping, tearing or otherwise rupturing. Failure occurred after application of a load of 1,100 pounds.

In another series of trails, samples corresponding to the preferred embodiment bed pad 400 illustrated in FIG. 17 were subjected to various load testing as follows. Specifically, three (3) bed pads corresponding to the pads 400 utilizing a single sheet layer 430 and a single adhesive layer 440 along with a padding layer 450, were attached to the previously described vertical lift assembly and rectangular frame. The samples used a padding layer obtained from Troy LLC, of nonwoven 100% polyester fibers having a basis weight of 15 ounces per square yard, with a sheet layer of Ahlstrom 7844 material. Sample A was affixed to the frame by using four straps extending between the frame and four hand holds. Sample B was affixed to the frame by using eight straps extending between the frame and eight hand holds. Sample C was affixed to the frame by using twelve straps extending between the frame and twelve hand holds. As previously described, the straps were equally spaced (or approximately so) from one another. As previously described, 50 pound bags and at later stages, lighter bags, were incrementally loaded until the sample failed.

Sample A using four hand holds supported a load of 450 pounds without ripping, tearing, or otherwise rupturing, and failed at 550 pounds. Sample B using eight hand holds supported a load of 850 pounds without ripping, tearing, or otherwise rupturing, and failed at 950 pounds. Sample C using twelve hand holds supported a load of 1860 pounds without ripping, tearing, or otherwise rupturing, and failed at 1970 pounds.

### D. Weight Capacity Drag Test

In this investigation, a bed pad sample corresponding to the preferred embodiment pad 300 and using the previously noted padding layer with 10 ounce basis weight and Suprel® 7714 for the sheet layer was used. A load of 250 pounds in the form of five (5) 50 pound bags was evenly applied across the pad, the pad extended upon pavement, as typically present in a parking lot. The pad was positioned such that the sheet layer, i.e. the Suprel® 7714 layer, was contacting the pavement. The loaded pad was then dragged across the pavement at a speed of about 2 to 3 miles per hour (i.e. typical walking speed) for a distance of 100 yards. The loaded bed pad was pulled by its two hand holds defined along an end of the pad. After dragging for the noted 100 yard distance, each of the two hand holds were intact, i.e. had not ripped or torn. In addition, the entire face surface of the pad which had contacted the pavement was intact such that no holes or regions had worn through the thickness of the pad as a result of abrasion from the pavement.

A series of comparative trials were also conducted to investigate the strength and durability benefits provided by a Tyvek® bottom layer in a bed pad according to the present invention. A set of bed pads, such as pads using Tyvek® as described herein, differing in only the use of a Tyvek® underside layer, were loaded with 180 pounds of weight (to simulate a patient) and then dragged across an asphalt parking lot. Each bed pad tested was dragged for a distance of 400 yards. Damage to the underside of each bed pad was assessed based upon the degree of tears, rips, or ruptures of the material along the underside of the pad. The bed pads utilizing the Tyvek® layer performed significantly better than the bed pads not utilizing Tyvek®. The bed pads without a Tyvek® underside layer exhibited approximately twice the amount and degree of damage as did the bed pads with a Tyvek® bottom layer.

It will be understood that any of the features of the various embodiments may be combined or used in conjunction with any of the other features of other embodiments described herein.

All patents, published patent documents, and articles referenced herein are hereby incorporated by reference in their entirety.

The development has been described with reference to the preferred embodiments. Still, other modifications and alterations will occur to others upon a reading and understanding of this specification. The specification is intended to include all such modifications and alterations to the extent they come within the general concept hereinabove described.

What is claimed is:

1. A flexible thin pad comprising:
at least one sheet layer, the sheet layer being breathable;
a padding layer comprising polyester fibers;
wherein the at least one sheet layer and the padding layer are adhesively bonded to one another by use of a hot melt polyester based adhesive layer disposed between the at least one sheet layer and the padding layer;
wherein the pad exhibits a surface area to thickness ratio of from about 800:1 to about 50,000:1;
wherein the pad can support loads of 400 pounds without ripping, tearing or otherwise rupturing;
wherein the pad can absorb and retain 1 ounce of liquid for every 40 square inches of pad surface area.

2. The thin pad of claim 1 wherein the pad can support loads of 500 pounds without ripping, tearing or otherwise rupturing.

3. The thin pad of claim 1 wherein the pad can absorb and retain 1 ounce of liquid for every 30 square inches of pad surface area.

4. The thin pad of claim 1 wherein the thickness of the pad is 0.125 inches to 0.375 inches.

5. The thin pad of claim 1 wherein the pad defines a plurality of handles around a peripheral region of the pad.

6. The thin pad of claim 5 wherein each of the handles is in the form of a U-shaped incision through the pad.

7. The thin pad of claim 1 wherein the padding layer is a layer of nonwoven 100% polyester fibers.

8. The thin pad of claim 1 wherein the at least one sheet layer comprises a blend of polyethylene fibers and polyester fibers.

9. The thin pad of claim 1 wherein the at least one sheet layer comprises a blend of cellulose fibers and polyester fibers.

10. The flexible thin pad of claim 1 wherein the at least one sheet layer includes two sheet layers, and the padding layer is disposed between the two sheet layers.

11. A flexible thin pad comprising:
at least one sheet layer, the sheet layer being breathable, the sheet layer comprising a blend of polyethylene fibers and polyester fibers;
a padding layer comprising polyester fibers;
wherein the at least one sheet layer and the padding layer are adhesively bonded to one another by use of a hot melt polyester based adhesive layer disposed between the at least one sheet layer and the padding layer;
wherein the pad exhibits a surface area to thickness ratio of from about 800:1 to about 50,000:1;
wherein the pad can support loads of 400 pounds without ripping, tearing or otherwise rupturing;
wherein the pad can absorb and retain 1 ounce of liquid for every 40 square inches of pad surface area;
wherein the pad exhibits a width to length ratio of about 23% to about 40%.

12. The pad of claim 11 wherein the ratio of width to length is from about 27% to about 35%.

13. The pad of claim 11 wherein the pad can support loads of 500 pounds without ripping, tearing or otherwise rupturing and the pad retains 1 ounce of liquid for every 30 square inches of pad surface area.

14. The pad of claim 11 wherein the ratio of surface area as measured on one face to thickness is from about 2,000:1 to about 40,000:1.

15. The pad of claim 11 wherein the pad has a thickness of from about 0.125 inches to about 0.375 inches.

16. A flexible thin pad comprising:
at least one sheet layer, the sheet layer being breathable, the sheet layer comprising a blend of cellulose fibers and polyester fibers;
a padding layer comprising polyester fibers;
wherein the at least one sheet layer and the padding layer are adhesively bonded to one another by use of a hot melt polyester based adhesive layer disposed between the at least one sheet layer and the padding layer;
wherein the pad exhibits a surface area to thickness ratio of from about 800:1 to about 50,000:1;
wherein the pad can support loads of 400 pounds without ripping, tearing or otherwise rupturing;
wherein the pad can absorb and retain 1 ounce of liquid for every 40 square inches of pad surface area;
wherein the pad exhibits a width to length ratio of from about 46% to about 79%.

17. The pad of claim 16 wherein the ratio of width to length is from about 53% to about 70%.

18. The pad of claim 16 wherein the pad can support loads of 500 pounds without ripping, tearing or otherwise rupturing and the pad retains 1 ounce of liquid for every 30 square inches of pad surface area.

19. The pad of claim 16 wherein the ratio of surface area as measured on one face to thickness is from about 2,000:1 to about 40,000:1.

20. The pad of claim 16 wherein the pad has a thickness of from about 0.125 inches to about 0.375 inches.
